(19) United States
(12) Patent Application Publication
(10) Pub. No.: US 2026/0239069 A1
(43) Pub. Date: Aug. 13, 2026

(54) Wireless Device, Network Node, and Methods Performed Thereby, for Handling One or More Application Layer Measurements

(71) Applicant: Telefonaktiebolaget LM Ericsson (publ), Stockholm (SE)

(72) Inventors: Vengatanathan Krishnamoorthi, Linköping (SE); Johan Rune, Lidingö (SE); Cecilia Eklöf, Täby (SE); Luca Lunardi, Genova (IT); Filip Barac, Huddinge (SE)

(21) Appl. No.: 19/154,224

(22) PCT Filed: Feb. 15, 2024
(86) PCT No.: PCT/SE2024/050146

§ 371 Date: Aug. 6, 2025

Related U.S. Application Data
(60) Provisional application No. 63/485,281, filed on Feb. 16, 2023.

(51) Int. Cl. H04W 24/10; H04L 41/5067; H04W 76/20; H04W 80/02

(52) U.S. Cl. CPC H04W 24/10; H04L 41/5067; H04W 76/20; H04W 80/02

(57) ABSTRACT

A method, performed by a wireless device (131), for handling one or more application layer measurements. The wireless device (131) operates in a wireless communications network (100). The wireless device (130) receives (204), a respective first indication from a network node (110) operating in the wireless communications network (100). The first 5 indication indicates: a) a respective first configuration of a respective second indication of the one or more application layer measurements, and b) that the respective first configuration is based on one or more respective measurements, by the wireless device (131) or other wireless devices (132). The one or more respective measurements comprise at least one of: application layer measurements and radio layer measurements. The wireless device (130) 10 sends (206) a respective application layer measurement report based on the indicated respective first configuration.

### TECHNICAL FIELD

The present disclosure relates generally to a wireless device and methods performed thereby for handling one or more application layer measurements. The present disclosure further relates generally to a network node and methods performed thereby, for handling the one or more application layer measurements.

### BACKGROUND

Wireless devices within a wireless communications network may be e.g., User Equipments (UEs), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., MCE, evolved Node B (“eNB” or E-UTRAN NodeB), “eNodeB”, “NodeB”, “B node”, Transmission Point (TP), or BTS (Base Transceiver Station), depending on the technology and terminology used. The base stations may be of different classes such as e.g., Wide Area Base Stations, Medium Range Base Stations, Local Area Base Stations, Home Base Stations, pico base stations, etc. . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network (CN), which may be referred to as Next Generation (NG) Core Network, abbreviated as NG-CN, NGC, 5G CN or 5G Core (5GC). NG may be understood to refer to the interface/reference point between the Radio Access Network (RAN) and the CN in 5G/NR. In a 5G System (5GS), a radio base station in NR may be referred to as a gNB or 5G Node B. An NR UE may be referred to as an nUE.

### Internet of Things (IoT)

The Internet of Things (IoT) may be understood as an internetworking of communication devices, e.g., physical devices, vehicles, which may also be referred to as “connected devices” and “smart devices”, buildings and other items-embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g. a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices is expected to be stationary, e.g., gas and electricity meters, vending machines, etc.

### Machine Type Communication (MTC)

Machine Type Communication (MTC) has in recent years, especially in the context of the Internet of Things (IOT), shown to be a growing segment for cellular technologies. An MTC device may be a communication device, typically a wireless communication device or simply user equipment, that is a self and/or automatically controlled unattended machine and that is typically not associated with an active human user in order to generate data traffic. An MTC device may be typically simpler, and typically associated with a more specific application or purpose, than, and in contrast to, a conventional mobile phone or smart phone. MTC involves communication in a wireless communication network to and/or from MTC devices, which communication typically may be of quite different nature and with other requirements than communication associated with e.g., conventional mobile phones and smart phones. In the context of and growth of the IoT, it is evident that MTC traffic will be increasing and thus needs to be increasingly supported in wireless communication systems.

### Overview of the QoE Framework

### Legacy QoE Measurements

Quality of Experience (QoE) measurements, also referred to as “application layer measurements”, have been specified for LTE, Universal Mobile Telecommunications System (UMTS) and were recently specified for 5G NR in the 3GPP Rel-17. The purpose of the QoE measurements may be understood to be to measure the experience of the end user using certain applications. Currently, the QoE measurements are specified and supported for Dynamic Adaptive Streaming over Hypertext Transfer Protocol (DASH) streaming, Mobility Telephony Service for Internet Protocol Multimedia Subsystem (MTSI) services, and Virtual Reality (VR).

The existing methods in LTE and UMTS may be understood to be similar with the overall principles as follows. QoE Measurement Collection (QMC) may be understood to enable configuration of application layer measurements in the UE and transmission of QoE measurement result files, commonly referred to as “QoE reports”, to the network by means of Radio Resource Control (RRC) signaling. An application layer measurement configuration, also called QoE measurement configuration or QoE configuration, that the RAN may receive from the Operation and Maintenance (OAM) system, or the Core Network (CN), may be encapsulated in a transparent container, which may be forwarded to a UE in a downlink RRCReconfiguration message. An application layer measurement report, also called QoE report, that the UE Access Stratum (UE AS) or UE RRC layer may receive from the UE's higher layer, application layer, may be encapsulated in a transparent container and sent to the network in an uplink RRC message, MeasurementAppLayerReport. The RAN may then forward the QoE report to a Measurement Collector Entity (MCE).

In 3GPP Rel-17 “Study on NR QoE management and optimizations for diverse services” with the purpose to study approaches for QoE measurements in NR was finalized and concluded. According to this item, QoE management in NR may not just collect the QoE parameters of streaming services but also consider the typical performance requirements of diverse services, e.g., Augmented Reality (AR)/VR and Ultra-Reliable Low-Latency Communication (URLLC), of which at least VR was covered in 3GPP Rel-17. Based on requirements of services, the NR study also included more adaptive QoE management schemes that may enable network optimization to satisfy user experience for diverse services.

The configuration data related to QoE measurements, in standard specifications typically referred to as application layer measurements, may consist of a service type indication, an indication of an area in which the measurements may have to be performed, denoted area scope, an Internet Protocol (IP) address of the entity the collected measurement results, i.e., the QoE reports, may need to be sent to, often referred to as a MCE, spelled out as Measurement Collector Entity or Measurement Collection Entity, and a set of instructions of which type of measurements that may need to be performed and details of how these measurements may need to be performed. These instructions may be understood to be intended for the application layer in the UE and may be placed in a “container” which may not be read and interpreted by the network entities handling it, e.g., forwarding it to the UE, as well as the UE Access Stratum. The currently specified service types are MTSI and streaming service (DASH), and in 3GPP Rel-17, VR was added. An area scope may be defined in terms of cells or network related areas. In UMTS, an area scope may be defined as either a list of cells, a list of routing areas, or a list of tracking areas. In LTE, an area scope may be defined as either a list of cells or a list of tracking areas. In NR, an area scope may be defined as either a list of cells, e.g., a list of NR Cell Global Identifiers (NCGIs), or a list of tracking areas, e.g., a list of Tracking Area Codes (TACs).

QoE, and in particular, the QoE configuration, may come in two flavors: management-based (m-based) QoE configuration and signaling-based (s-based) QoE configuration. In both cases, the QoE configuration may originate in the OAM system or some other administrational entity, e.g., dealing with customer satisfaction. All of these entities are in this document referred to as the OAM system, where the OAM system may also contain further entities.

With the m-based QoE, the OAM system may be typically interested in general QoE statistics from a certain area, configured as an area scope. The m-based QoE configuration may be sent directly from the OAM system to the RAN nodes controlling cells that may be within the area scope. Each RAN node may then select UEs that may be within the area scope, and may also fulfill any other relevant condition, such as supporting the concerned application/service type, and sending the m-based QoE configuration to these UEs.

With the s-based QoE, the OAM system may be understood to be interested in collecting QoE measurement results from a specific UE, e.g., because the user of the UE has filed a complaint. The OAM system may send the s-based QoE configuration to the Home Subscriber Server (HSS), in Evolved Packet System (EPS)/LTE, or Unified Data Management (UDM) in 5GS/NR, which may forward the QoE configuration to the UE's current core network node (CN), e.g., an Mobility Management Entity (MME) in EPS/LTE or an Access and Mobility Management Function (AMF) in 5G/NR. The CN may then forward the s-based QoE configuration to the RAN node that may serve the concerned UE and the RAN may forward it to the UE.

Forwarded to the UE may be the service type indication and the container with the measurement instructions. The UE may be understood to not be aware of whether a received QoE configuration is m-based or s-based. In legacy systems, the QoE framework may be integrated with the Trace functionality and a Trace Identifier/Identity (ID) may be associated with each QoE configuration. In NR, the QoE functionality may be logically separated from the Trace functionality, but it may still partly reuse the Trace signaling 15 mechanisms. In NR, and possibly in LTE, a globally unique QoE reference, formed of Mobile Country Code (MCC)+Mobile Network Code (MNC)+QoE Measurement Collection (QMC) ID, where the QMC ID may be a string of 24 bits, may be associated with each QoE configuration. The QoE reference may be included in the container with measurement instructions and also sent to the RAN, e.g., the gNB in NR. For the communication between the gNB and the UE, the QoE reference may be replaced by a shorter identifier denoted as measConfigAppLayerId, which may be locally unique within a UE, e.g., there may be a one-to-one mapping between a measConfigAppLayerId and a QoE reference for each QoE configuration provided to a UE. The measConfigAppLayerId may be stored in the UE Access Stratum and also forwarded in an ATtention (AT) Command, which may be understood to be the type of instructions used in the communication between the UE's modem part and the UE's application layer, together with the service type indication and the container with the measurement instructions.

Reports with collected QoE reports may be sent from the UE application layer to the UE Access Stratum, which may forward them to the RAN, which in turn may forward them to the MCE. These QoE reports may be placed in a “container”, which may be uninterpretable for both the UE Access Stratum and the RAN. QoE reporting may be configured to be periodic or only to be sent at the end of an application session. Furthermore, the RAN may instruct the UE to pause QoE reporting, e.g., in case the cell/gNB may be in a state of overload.

The RAN may not be automatically aware of when an application session with an associated QoE measurement session is ongoing, and the UE Access Stratum may also not be automatically aware of this. To alleviate this, session “start”/“stop” indications which may be sent from the application layer in the UE to the UE AS and from the UE AS to the RAN were introduced. A session “stop” indication may be explicit or may be implicit in the form of a QoE report sent when the application session and the associated QoE measurement session may be concluded.

The RAN may decide to release a QoE configuration in a UE at any time, as an implementation-based decision. Typically, it may be done when the UE may have moved outside a configured area scope.

One opportunity provided by legacy solutions may also be to be able to keep the QoE measurement for the whole session, even during a handover situation. It is also discussed to let the UE continue with the QoE measurements on an ongoing application session until the application session may end, even if the UE in the meantime may move out of the configured area scope.

### RAN Visible QoE (RVQoE) Measurements

QoE measurements, and their reported results, may be understood to be intended for analysis in the Operation and Maintenance (O&M) system, or in other entities that may neither belong to the core network nor belong to the RAN, and subsequent possible non-real-time optimizations. The QoE reports may be forwarded transparently by the RAN to a configured receiver, e.g., an MCE. However, the RAN may also benefit from receiving measurement results of metrics measured or collected at the application layer, e.g., as a complement to the more radio related measurements, e.g., the Radio Resource Management (RRM) measurements, e.g., Reference Signal Received Power (RSRP), Reference Signal Received Quality (RSRQ), Signal to Interference and Noise Ratio (SINR), etc. For instance, the RAN may use such measurement results for real-time or semi-real-time adaptations or optimizations of the treatment of an ongoing application session, e.g., in terms of scheduling priorities.

For this reason, in 3GPP release 17, 3GPP introduced so-called RAN Visible QoE, which may be understood to comprise periodic reporting of measured application layer metrics in a format that the RAN may understand. These metrics, denoted as RVQoE metrics, are in release 17 limited to QoE metrics, in particular the Buffer Level QoE metric for DASH, specified in 3GPP TS 26.247 version 17.1.0, which in turn references annex D.4.5 in ISO/IEC 23009-1, and represented in 3GPP TS 38.331 version 17.2.0, i.e., the RRC specification, as the AppLayerBufferLevel-r17 field, and the Playout Delay for Media Start-up QoE metric for DASH, specified in 3GPP TS 26.247 version 17.1.0 and represented in 3GPP TS 38.331 version 17.2.0, i.e., the RRC specification, as the playoutDelayForMedia Startup-r17 field. In addition to these two RVQoE metrics, a MeasurementReportAppLayer message may contain a Protocol Data Unit (PDU) session ID list, in the form of the pdu-SessionldList-r17 field, as part of the reported RAN Visible QoE (RVQoE) information, i.e., in the RAN-VisibleMeasurements-r17 Information Element (IE).

The configuration for QoE and RVQoE may be performed via an RRC reconfiguration message containing the AppLayerMeasConfig information element shown in Table 1. The configuration of legacy QoE metrics may be done via the measConfigAppLayerContainer IE, which may be understood to specify the configuration to the application-layer in the UE as an octet string, following XML. RVQoE parameters may be specified as part of the RAN-VisibleParameters IE.

TABLE 1
AppLayerMeasConfig message

-- ASN1START
-- TAG-APPLAYERMEASCONFIG-START

| | |
|---|---|
| AppLayerMeasConfig-r17 ::= | SEQUENCE { |

| | |
|---|---|
| measConfigAppLayerToAddModList-r17 | SEQUENCE (SIZE (1..maxNrofAppLayerMeas- |

| | |
|---|---|
| r17)) OF MeasConfigAppLayer-r17 | OPTIONAL, -- Need N |

| | |
|---|---|
| measConfigAppLayerToReleaseList-r17 | SEQUENCE (SIZE (1..maxNrofAppLayerMeas- |

| | |
|---|---|
| r17)) OF MeasConfigAppLayerId-r17 | OPTIONAL, -- Need N |

| | |
|---|---|
| rrc-SegAllowed-r17 | ENUMERATED {enabled} |

OPTIONAL, -- Need R
...
}

| | |
|---|---|
| MeasConfigAppLayer-r17 ::= | SEQUENCE { |

| | |
|---|---|
| measConfigAppLayerId-r17 | MeasConfigAppLayerId-r17, |

| | |
|---|---|
| measConfigAppLayerContainer-r17 | OCTET STRING (SIZE (1..8000)) |

OPTIONAL, -- Need N

| | |
|---|---|
| serviceType-r17 | ENUMERATED {streaming, mtsi, vr, spare5, spare4, spare3, |

spare2, spare1} OPTIONAL, -- Need M

| | |
|---|---|
| pauseReporting-r17 | BOOLEAN |

OPTIONAL, -- Need M

| | |
|---|---|
| transmissionOfSessionStartStop-r17 | BOOLEAN |

OPTIONAL, -- Need M

| | |
|---|---|
| ran-VisibleParameters-r17 | SetupRelease {RAN-VisibleParameters-r17} |

OPTIONAL, -- Cond ServiceType
...
}

| | |
|---|---|
| RAN-VisibleParameters-r17 ::= | SEQUENCE { |
| ran-VisiblePeriodicity-r17 | ENUMERATED {ms120, ms240, ms480, ms640, ms1024} |

OPTIONAL, -- Need S

| | |
|---|---|
| numberOfBufferLevelEntries-r17 | INTEGER (1..8) |

```
OPTIONAL, -- Need R
  reportPlayoutDelayForMediaStartup-r17 BOOLEAN
OPTIONAL, -- Need M
  ...
}
-- TAG-APPLAYERMEASCONFIG-STOP
-- ASN1STOP
```

### The MeasurementReportAppLayer Message

A UE may use the MeasurementReportAppLayer message to report measured QoE metrics and measured RVQoE metrics. It may be as specified as follows in Table 2 and Table 3, in 3GPP TS 38.331 version 17.2.0:

TABLE 2
-- ASN1START
-- TAG-MEASUREMENTREPORTAPPLAYER-START

| | |
|---|---|
| MeasurementReportAppLayer-r17 ::= | SEQUENCE { |

| | |
|---|---|
| criticalExtensions | CHOICE { |

| | |
|---|---|
| measurementReportAppLayer-r17 | MeasurementReportAppLayer-r17-IEs, |

| | |
|---|---|
| criticalExtensionsFuture | SEQUENCE { } |

}
}
MeasurementReportAppLayer-r17-IEs ::= SEQUENCE {

| | |
|---|---|
| measurementReportAppLayerList-r17 | MeasurementReportAppLayerList-r17, |

| | | |
|---|---|---|
| lateNonCriticalExtension | OCTET STRING | OPTIONAL, |
| nonCriticalExtension | SEQUENCE{ } | OPTIONAL |

}
MeasurementReportAppLayerList-r17 ::= SEQUENCE (SIZE (1..maxNrofAppLayerMeas-r17))
OF MeasReportAppLayer-r17

| | |
|---|---|
| MeasReportAppLayer-r17 ::= | SEQUENCE { |
| measConfigAppLayerId-r17 | MeasConfigAppLayerId-r17, |

| | | |
|---|---|---|
| measReportAppLayerContainer-r17 | OCTET STRING | OPTIONAL, |

| appLayerSessionStatus-r17 | ENUMERATED {started, stopped} OPTIONAL, | |
|---|---|---|
| ran-VisibleMeasurements-r17 | RAN-VisibleMeasurements-r17 | OPTIONAL |

}
RAN-VisibleMeasurements-r17 :: = SEQUENCE {

| | |
|---|---|
| appLayerBufferLevelList-r17 | SEQUENCE (SIZE (1..8)) OF AppLayerBufferLevel-r17 |

OPTIONAL,

| | |
|---|---|
| playoutDelayForMediaStartup-r17 INTEGER (0..30000) | OPTIONAL, |

| | |
|---|---|
| pdu-SessionIdList-r17 | SEQUENCE (SIZE (1..maxNrofPDU-Sessions-r17)) OF PDU- |

SessionID OPTIONAL,
...
}
AppLayerBufferLevel-r17 ::= INTEGER (0..30000)
-- TAG-MEASUREMENTREPORTAPPLAYER-STOP
-- ASN1STOP

TABLE 3
MeasurementReportAppLayer field descriptions

appLayerBufferLevelList
The field indicates a list of application layer buffer levels, and each AppLayerBufferLevel
indicates the application layer buffer level in ms. Value 0 corresponds to 0 ms, value 1
corresponds to 10 ms, value 2 corresponds to 20 ms and so on. If the buffer level is larger
than the maximum value of 30000 (5 minutes), the UE reports 30000.
appLayerSessionStatus
Indicates that an application layer measurement session in the application layer starts or
ends.
playoutDelayForMediaStartup
Indicates the application layer playout delay for media start-up in ms. Value 0 corresponds
to 0 ms, value 1 corresponds to 1 ms, value 2 corresponds to 2 ms and so on. If the playout
delay for media start-up is larger than the maximum value of 30000 ms, the UE reports
30000.
measReportAppLayerContainer
The field contains application layer measurement report, see Annex L (normative) in TS
26.247 [68], clause 16.5 in TS 26.114 [69] and TS 26.118 [70].
pdu-SessionIdList
Contains the identity of the PDU session, or the identities of the PDU sessions, used for
application data flows subject to the RAN visible application layer measurements.

AT commands may be used for communication between the AS, radio, layer and the application layer in the UE. The AT commands may be as defined in 3GPP TS 27.007 version 17.6.0. The AT commands may be used in QoE for transferring of the configuration from the RRC layer to the application and for transferring of reports from the application layer to the RRC layer.

The AT command used for sending a QoE configuration, and/or a RVQoE configuration, from the UE AS to the UE application layer in NR is denoted as +CAPPLEVMCNR and may be as specified as follows in 3GPP TS 27.007 version 17.6.0:

TABLE 8.84-1
+CAPPLEVMCNR parameter command syntax

| Command | Possible response(s) |
|---|---|
| +CAPPLEVMCNR=[<n | +CME ERROR: <err> |
| >] | |
| +CAPPLEVMCNR? | +CAPPLEVMCNR: <n> |
| +CAPPLEVMCNR=? | +CAPPLEVMCNR: (list of supported |
| | <n>s) |

### DESCRIPTION

This command allows control of the application level measurement configuration according to 3GPP TS 38.331 [160]. The set command controls the presentation of the unsolicited result code+CAPPLEVMCNR: (list of [<CR><LF>,<meas_config_app_layer_id>, [<start-stop_measurement>, [<ran_visible_release_only>]], [<app-meas_config_file_length>,<app-meas_config-file>], [<transmission_of_session_start-end>], [<ran_visible_periodicity>], [<number_of_buffer_level_entries>], [<report_initial_playout delay>], [<app-meas_service_type>]] s) providing data for the configuration. Refer clause 9.2 for possible <err>values.

Read command returns the current value of <n>.

Test command returns values supported as a compound value.

### Defined Values

[Defined values are omitted for brevity of the description-see section 8.84 in 3GPP TS 27.007 version 17.6.0.]

The AT command used for sending QoE reports, and/or RVQoE reports, from the UE application layer to the UE AS in NR may be denoted as +CAPPLEVMRNR and may be as specified as follows in 3GPP TS 27.007 version 17.6.0:

TABLE 8.85-1
+CAPPLEVMR action command syntax

| | Possible |
|---|---|
| Command | response(s) |
| +CAPPLEVMR=(list of [<CR><LF><app- | +CME |
| meas_report_length>,<app- | ERROR: <err> |
| meas_report>,<meas_config_app_layer_id>],[<nu | |
| mber-of-pdu-session_id-entries>,(list of <pdu- | |
| session_id>s)],[<number_of_buffer_level_entries | |
| >,(list of <application_layer_buffer- | |
| level>s)],[<qoe_measurement_status>],[<playout | |
| _delay_for_media_startup>]s) | |
| +CAPPLEVMR=? | |

### DESCRIPTION

This command may be understood to allow the Mobile Terminal (MT) to provide a list of application level measurement reports according to 3GPP TS 38.331 [160]. Refer clause 9.2 for possible <err>values.

### Defined Values

[Defined values are omitted for brevity of the description-see section 8.84 in 3GPP TS 27.007 version 17.6.0.]

In LTE, the corresponding AT commands may be denoted respectively as +CAPPLEVMC and +CAPPLEVMR.

### SUMMARY

As part of the development of embodiments herein, one or more challenges with the existing technology will first be identified and discussed.

RVQoE reports may be understood to enable the RAN to obtain observability of a client's buffer conditions for the DASH streaming use-case via the AppLayerBufferLevel RVQoE metric. The intention with RVQoE measurement and reporting may be understood to be to enable the RAN to undertake resource optimization actions, such that end-user QoE and network performance may be optimized in accordance with the existing goals.

With the streaming video use-case, DASH, it may be noted that playback stall, that is, playback stopped due to the playback buffer being empty, may be understood to perhaps have the most significant impact on the end-user QoE of a playback session. The possibility of obtaining the client's buffer occupancy during playback at a certain periodicity, may enable the RAN to have a direct insight into the client's playback session. It may be also reasonable to assume that when the playback buffer is close to zero, or if the drop in buffer size over a period of time has been significant, the RAN may undertake actions such that more bandwidth may be allocated to that application session/UE. This may be realized by either adding more component carriers to the UE, setting up or extending dual connectivity, or increasing the resource allocation to the UE within the existing cells, prioritizing the session's Quality of Service (QOS)/bearer settings, and via other means available at the RAN.

With DASH, the downloading logic, in terms of the encoding rate, also referred to as the representation, that may be chosen for the next video chunk/segment may be determined by the UE's application layer. A simplified description of this UE application-level procedure may be as follows. The primary inputs to this procedure may be the historical throughput estimate observed during the download of previous video chunks/segments, and the Media Presentation Description (MPD), in addition, the client may also use the buffer size, the previous played encodings, etc., as inputs. Based on the input, the application client may attempt to maximize the quality of the downloaded video based on the available encodings/representations specified in the MPD, constrained by the available/estimated throughput.

The scenario may be considered where the RAN has reacted to a UE that would have imminently stalled a video playout in a DASH application client without help from the network, i.e., the RAN may have temporarily allocated more radio resources to the UE to quickly download content and increase its buffer occupancy. Nevertheless, when noticing the increased available bitrate, the application client in the UE may assume that the network conditions may be good/may have improved, and the representation/encoding rate selection mechanism may download future chunks at higher or very high encoding rates. By downloading chunks at higher representation/encoding rates, the corresponding increase in the buffer size, measured as the playtime of the chunks, may be comparatively lower against a conservative selection of representation/encoding rate. As a result, the additionally allocated resources are not fully utilized for the intended purpose, which is to increase the buffered video play time to remove the threat of stalling in the future. In other words, to prevent stalling of a video, the RAN temporarily allocates more resources to a UE, but, instead of interpreting this as a “help” from the RAN to prevent stalling, the UE understands this action as an indication of improved channel quality and starts requiring data at higher encoding rates.

In a similar scenario, but with an alternative outcome, and a different view of what is problematic, the RAN may react to a UE that would have imminently stalled a video playout in a DASH application client without help from the network, i.e., the RAN temporarily may allocate more radio resources to the UE to quickly download content and increase the application client's buffer occupancy. However, the application client may be unaware of this coming, or just initiated increase in the available bitrate and may continue to use an unnecessarily low encoding rate, thereby not providing the best service quality to the user that the circumstances actually would allow. Furthermore, when the DASH application client in the UE may eventually notice the increased available bitrate, the application client may misinterpret this temporary boost from the RAN, and mistakenly assume that the network conditions may be good/may have improved, and the encoding rate selection mechanism may download upcoming chunks at very high encoding rates, while the RAN, concluding that its temporary boost of the UE has achieved its goal, may go back to the previous treatment of the UE. As a result, the application client may choose a higher encoding rate than what would be appropriate for the network conditions prevailing after the temporary boost.

From the above examples it follows that, in some cases, to avoid the UE and the RAN acting in an uncoordinated manner, it may be necessary to inform the UE about the intervention/countermeasure taken by the RAN, triggered by measurement results received in an RVQoE report. However, the existing methods do not provide the UE with the awareness about RAN intervention.

According to the foregoing, it is an object of embodiments herein to improve the handling of one or more application layer measurements.

According to a first aspect of embodiments herein, the object is achieved by a method, performed by a wireless device. The method is for handling one or more application layer measurements. The wireless device operates in a wireless communications network. The wireless device receives a respective first indication from a network node operating in the wireless communications network. The first indication indicates: a) a respective first configuration of a respective second indication of the one or more application layer measurements, and b) that the respective first configuration is based on one or more respective measurements by the wireless device or other wireless devices. The one or more respective measurements comprise at least one of: application layer measurements and radio layer measurements. The wireless device then sends a respective application layer measurement report based on the indicated respective first configuration.

According to a second aspect of embodiments herein, the object is achieved by a method, performed by the network node. The method is for handling the one or more application layer measurements. The network node operates in the wireless communications network. The network node sends one or more respective first indications to at least one wireless device of one or more wireless devices. Each of the one or more respective first indications indicates: a) a respective first configuration of a respective second indication of the one or more respective application layer measurements, and b) that the respective first configuration is based on the one or more respective measurements, by the wireless device or other wireless devices. The one or more respective measurements comprise at least one of: application layer measurements and radio layer measurements. The network node then receives the respective application layer measurement report from the wireless device based on the indicated respective first configuration.

According to a third aspect of embodiments herein, the object is achieved by the wireless device, configured to perform the method. The wireless device may be understood to be the one or more application layer measurements. The wireless device is configured to operate in the wireless communications network. The wireless device is configured to receive, the respective first indication from the network node configured to operate in the wireless communications network. The first indication is configured to indicate: a) the respective first configuration of the respective second indication of the one or more application layer measurements, and b) that the respective first configuration is based on the one or more respective measurements, by the wireless device or the other wireless devices. The one or more respective measurements comprise at least one of: application layer measurements and radio layer measurements. The wireless device is also configured to send the respective application layer measurement report based on the respective first configuration configured to be indicated.

According to a fourth aspect of embodiments herein, the object is achieved by the network node, configured to perform the method. The network node may be understood to be for handling the one or more application layer measurements. The network node is configured to operate in the wireless communications network. The network node is configured to send the one or more respective first indications to at least one wireless device of the one or more wireless devices. Each of the one or more respective first indications is configured to indicate: a) the respective first configuration of the respective second indication of the one or more respective application layer measurements, and b) that the respective first configuration is based on the one or more respective measurements, by the wireless device or other wireless devices. The one or more respective measurements are configured to comprise at least one of: application layer measurements and radio layer measurements. The network node is also configured to receive the respective application layer measurement report from the wireless device based on the respective first configuration configured to be indicated.

By the wireless device receiving the respective first indication from the network node indicating the respective first configuration and b) that the respective first configuration is based on the one or more respective measurements by the wireless device or other wireless devices, the wireless device may be enabled to obtain information about the actions planned by the network node upon receiving reports from the wireless device or the other wireless devices. This may enable a tighter coordination between the network node and the applications running at the wireless device by exchanging information about the actions planned by the network node upon receiving the reports from the wireless device or the other wireless devices. The tighter coordination may ensure higher efficiency of interventions taken by the network node based on the measurement results and avoidance of unintended consequences due to lack of coordination. In other words, the applications of the wireless device, may make use of the allocated resources for purposes intended by the network node. For example, the wireless device may be enabled to refrain from assuming that that, for example, the respective first configuration may have been received due to the network conditions being good and/or having improved, and taking inappropriate actions in consequence.

By the wireless device then sending the respective application layer measurement report based on the indicated respective first configuration, the network node may be enabled to monitor the result of its respective first configuration and make any necessary changes accordingly to improve the QoE of the sessions of the wireless device and/or the other wireless devices.

### BRIEF DESCRIPTION OF THE DRAWINGS

Examples of embodiments herein are described in more detail with reference to the accompanying drawings, according to the following description.

FIG. 1 is a schematic diagram depicting an example of a wireless communications network, according to embodiments herein.

FIG. 2 is a flowchart depicting a method in a wireless device, according to embodiments herein.

FIG. 3 is a flowchart depicting a method in a network node, according to embodiments herein.

FIG. 4 is a schematic diagram illustrating a non-limiting example of methods disclosed herein, according to some examples.

FIG. 5 is a schematic block diagram illustrating two embodiments, in panel a) and panel b), of a wireless device, according to embodiments herein.

FIG. 6 is a schematic block diagram illustrating two embodiments, in panel a) and panel b), of a network node, according to embodiments herein.

FIG. 7 is a flowchart depicting an example method in a wireless device, related to embodiments herein.

FIG. 8 is a flowchart depicting an example method in a network node, related to embodiments herein.

FIG. 9 is a schematic block diagram illustrating an example of a communication system 900 in accordance with some embodiments.

FIG. 10 is a schematic block diagram illustrating a host 1000, which may be an embodiment of the host 916 of FIG. 9, in accordance with various aspects described herein.

FIG. 11 shows a communication diagram of a host 1102 communicating via a network node 1104 with a UE 1106 over a partially wireless connection in accordance with some embodiments.

### DETAILED DESCRIPTION

Certain aspects of the present disclosure and their embodiments may provide solutions to the challenges described in the Summary section or other challenges. Embodiments herein may be generally understood relate to a RVQoE-based RAN intervention indication. Particularly, embodiments herein may relate to an approach that may involve that the RAN may send an indication to the UE, possibly targeting a specific application, to inform about a planned or started or ended intervention triggered by received reported RVQoE measurement results, e.g., when the RAN may be attempting to increase the playback buffer size of a DASH video application in the UE, in a situation when the DASH video application may be under risk of imminent playback stalls. The indication may convey the period during which the RAN intervention may be active and other associated parameters, such as prioritization levels, expected bitrates due to prioritization, guidelines on selection or change of one adaptation and/or encoding from the DASH adaptation set depending on the planned and/or started and/or ended intervention, etc. The approach may also comprise means to perform coordinated actions across a subset of UEs, where one or more UEs in the subset may be prioritized by down prioritizing other UEs. The approach and the information contained therein may enable coordinated actions between the RAN, the application in the UE being prioritized, and other UEs or application sessions that may be indirectly affected.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

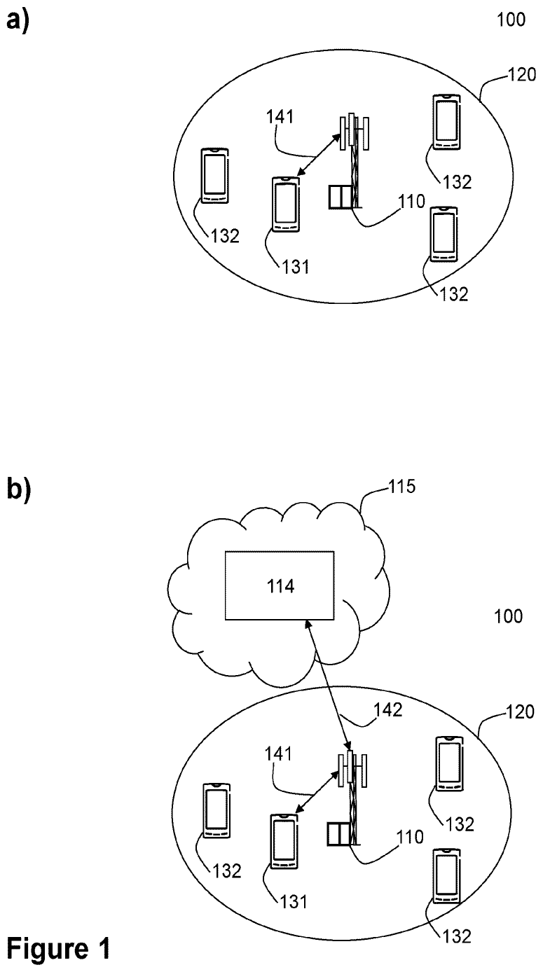

FIG. 1 depicts two non-limiting examples, in panel a) and panel b), respectively, of a wireless network or wireless communications network 100, sometimes also referred to as a wireless communications system, cellular radio system, or cellular network, in which embodiments herein may be implemented. The wireless communications network 100 may be a 5G system, 5G network, or Next Gen System or network. In other examples, the wireless communications network 100 may in addition, support other technologies such as, for example, Long-Term Evolution (LTE), e.g. LTE-M, LTE Frequency Division Duplex (FDD), LTE Time Division Duplex (TDD), LTE Half-Duplex Frequency Division Duplex (HD-FDD), LTE operating in an unlicensed band, such as LTE Licensed-Assisted Access (LAA), enhanced eLAA (eLAA), further enhanced LAA (feLAA) and/or MulteFire. Yet in other examples, the wireless communications network 100 may further support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. The wireless communications network 100 may typically support MTC, enhanced MTC (eMTC), IoT and/or NarrowBand IoT (NB-IoT). Thus, although terminology from 5G/NR and LTE may be used in this disclosure to exemplify embodiments herein, this should not be seen as limiting the scope of the embodiments herein to only the aforementioned system.

The wireless communications network 100 may comprise a plurality of network nodes, whereof a network node 110 is depicted in the non-limiting example of FIG. 1. In some embodiments, as depicted in FIG. 1, the network node 110 may be a radio network node. That is, a transmission point such as a radio base station, for example a gNB, or any other network node with similar features capable of serving a user equipment, such as a wireless device or a machine type communication device, in the wireless communications network 100. In some examples, such as that depicted in FIG. 1b, the network node 110 may be a distributed node, and may partially perform its functions in collaboration with a virtual node 114 in a cloud 115. The network node 110 may be directly connected to one or more core networks, e.g., to one or more network nodes in the one or more core networks.

The wireless communications network 100 may cover a geographical area, which in some embodiments may be divided into cell areas, wherein each cell area may be served by a radio network node, although, one radio network node may serve one or several cells. In the example of FIG. 1, the network node 110 serves a cell 120. The network node 110 may be of different classes, such as, e.g., macro base station, home base station or pico base station, based on transmission power and thereby also cell size. In some examples, the network node 110 may serve receiving nodes with serving beams. The network node 100 may support one or several communication technologies, and its name may depend on the technology and terminology used.

In some embodiments, the network node 110 may be a core network node, e.g., a network function.

A plurality of wireless devices may be located in the wireless communication network 100, whereof a wireless device 131, is depicted in the non-limiting example of FIG. 1. The wireless communications network 100 may also comprise other wireless devices 132, also depicted in the non-limiting example of FIG. 1. Three other wireless devices 132 are depicted in FIG. 1. This may be understood to be for illustration purposes only. There may be fewer or additional other wireless devices 132 located in the wireless communication network 100. The wireless device 131 and the other wireless devices 132 may be collectively referred to as the one or more wireless devices 131, 132. Also to simplify the figure, the other wireless devices 132 are depicted as being served by the network node 110 in the cell 120. However, any of the other wireless devices 132 may be served by one or more other network nodes. Any of the wireless device 131 and the other wireless devices 132 comprised in the wireless communications network 100 may be a wireless communication device such as a 5G User Equipment (UE) or nUE, or a UE, which may also be known as e.g., mobile terminal, wireless terminal and/or mobile station, a mobile telephone, cellular telephone, or laptop with wireless capability, just to mention some further examples. Any of the wireless device 131 and the other wireless devices 132 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, a sensor, IoT device, NB-IoT device, device equipped with a wireless interface, such as a printer or a file storage device, modem, or any other radio network unit capable of communicating over a radio link in a communications system. Any of the wireless device 131 and the other wireless devices 132 comprised in the wireless communications network 100 may be enabled to communicate wirelessly in the wireless communications network 100. The communication may be performed e.g., via a RAN, and possibly the one or more core networks, which may be comprised within the wireless communications network 100.

The wireless device 131 may be configured to communicate within the wireless communications network 100 with the network node 110 over a first link 141, e.g., a radio link. The network node 110 may be configured to communicate within the wireless communications network 100 with the virtual network node 144 over a second link 142, e.g., a radio link or a wired link. Any of other wireless devices 132 may be configured to communicate within the wireless communications network 100 with the network node 110 over a respective other link, e.g., a radio link. This is not depicted in FIG. 1 to simplify the figure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second” and/or “third” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a wireless device, such as the wireless device 131, e.g., a 5G UE, nUE or a UE, and embodiments related to a network node, such as the network node 110, e.g., a gNB.

Some embodiments herein will now be further described with some non-limiting examples, which may be combined with the embodiments just described.

In the following description, any reference to a/the UE, or simply “UE” may be understood to equally refer the wireless device 131; any reference to a/the gNB and/or a/the network and/or a/the RAN, and/or a/the RAN node and/or a/the network node may be understood to equally refer to the network node 110; any reference to a/the “cell” may be understood to equally refer to the first cell 121.

### GENERAL CONSIDERATIONS

Herein, the application layer in the wireless device 131 may be also referred to as the “UE application layer” or simply the “application layer”.

While the proposed approach and the use-case provided herein is DASH streaming, the concept of RAN-application coordination to manage QoE and transport impacts when RAN actions may be underway may be understood to not only be limited by the DASH streaming use-case. Some non-limiting examples may include applications whose characteristics may benefit from assistance and coordination with the RAN node, e.g., the network node 110, such as non-DASH services running over Multicast Broadcast Service (MBS), video conferencing, bulk file downloads, etc.

All references to the application layer may be with respect to the application layer of the wireless device 131, since RAN nodes may be understood to not have an application layer.

The term “service” may be often used as a short notation for “service type”, therefore “service” and “service types” may be seen as interchangeably, unless explicitly stated.

The approach proposed in embodiments herein may apply to both signaling- and management-based QoE/RVQoE measurements, but may also optionally be restricted to apply to only one of them.

The references to the CU in the present text equally apply to CU-Control Plane (CP), unless otherwise stated.

The term encoding rate may be understood to refer to the bit rate at which a video, or a version of the video, may be available for download from a DASH server. In literature, the encoding rate may be also referred to as the video representation and the set of encoding rates at which a DASH video may be available may be called as the representation set. These terms have been used interchangeably in this document.

The proposed approach may be presented on a non-limiting example of RVQoE measurements, where the intervention may be decided and communicated to the UE by the RAN. However, in some variants, the intervention may be decided by a core network entity, e.g., a network function or the receiver of QoE reports. Herein, the intervention may be communicated to the RAN, which may then indicate it to the UE, using one or more methods described in embodiments herein.

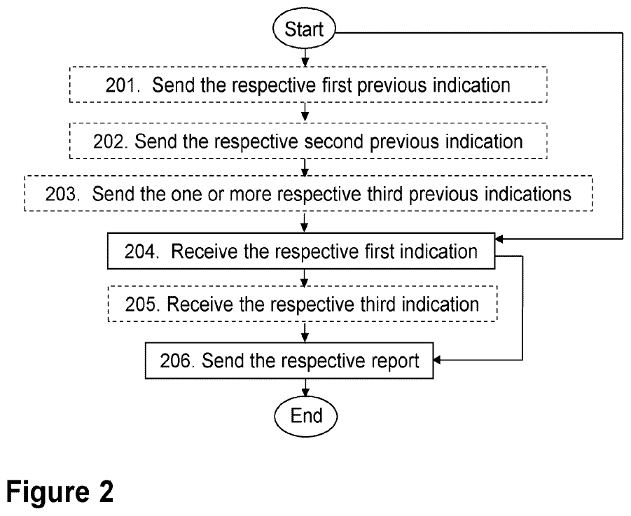

Embodiments of a method, performed by a wireless device, such as the wireless device 131, will now be described with reference to the flowchart depicted in FIG. 2. The method may be understood to be for handling one or more application layer measurements. The wireless device 131 operates in a wireless communications network, such as the wireless communications network 100. The method may be understood to be computer-implemented.

In some embodiments, the wireless communications network 100 may support New Radio (NR).

Several embodiments are comprised herein. The method may comprise one or more of the following actions. In some embodiments, all the actions may be performed. It should be noted that the examples herein may be not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 131 is depicted in FIG. 2. In FIG. 2 optional actions in some embodiments may be represented with dashed lines. In some embodiments, the actions may be performed in a different order than that depicted FIG. 2.

### Action 201

In this Action 201, the wireless device 131 may send a respective first previous indication.

The sending of the respective first previous indication in this Action 201 may be to the network node 110.

The sending in this Action 201 may be performed, e.g., via the first link 141.

The respective first previous indication may indicate one or more capabilities of the wireless device 131.

The one or more capabilities may be for the wireless device 131 to signal to the network node 110 that it may support receiving a respective first indication, which may be referred to as e.g., RAN assistance information, and to indicate the range of potential UE actions that may be possible, that is, supported by the wireless device 131. The wireless device 131 may therefore send the respective first previous indication before receiving the respective first indication. That is, embodiments herein may also comprise capability/ies of the wireless device 131, for the wireless device 131 to signal to the network node 110 that it may support receiving RAN assistance information and to indicate the range of potential UE actions that may be possible, that is, supported by the wireless device 131.

The respective first indication may indicate, e.g., at least one of: a) a respective first configuration, and b) that the respective first configuration is based on one or more respective measurements. The respective first configuration may be of a respective second indication; the respective second indication may be of one or more application layer measurements. The one or more respective measurements may be by the wireless device 131 or the other wireless devices 132. The one or more respective measurements may comprise at least one of: application layer measurements and radio layer measurements.

In some embodiments, at least one of the following may apply: a) the respective first configuration may be a Radio Access Network Visible Quality of Experience (RVQoE) parameter configuration, and b) the respective second indication may be one of: i) one or more parameters to perform the one or more application layer measurements, and ii) a report; the report may be on the one or more application layer measurements.

### Action 202

In this Action 202, the wireless device 131 may send a respective second previous indication.

The sending in this Action 202 may be to the network node 110.

The sending in this Action 202 may be performed, e.g., via the first link 141.

The respective second previous indication may indicate an application used by the wireless device 131, e.g., by sending an application identifier.

### Action 203

In some embodiments, in this Action 203, the wireless device 131 may send one or more respective third previous indications.

The sending in this Action 203 may be to the network node 110.

The sending in this Action 203 may be performed, e.g., via the first link 141.

The one or more respective third previous indications may indicate one or more respective measurements performed by the wireless device 131. The one or more respective measurements may comprise at least one of: application layer measurements and radio layer measurements.

In some embodiments, the respective third previous indication may be an RVQoE report.

### Action 204

In this Action 204, the wireless device 131 receives a first indication, e.g., the respective first indication.

The receiving in this Action 204 is from the network node 110 operating in the wireless communications network 100.

The receiving in this Action 204 may be performed, e.g., via the first link 141, e.g., in a dedicated or as part of a group message, e.g., received via system information.

The first indication indicates: a) the respective first configuration of the respective second indication of the one or more application layer measurements, and b) that the respective first configuration is based on the one or more respective measurements by the wireless device 131 or the other wireless devices 132; the one or more respective measurements comprise at least one of: application layer measurements and radio layer measurements.

As stated before, in some embodiments, at least one of the following may apply: a) the respective first configuration may be a RVQoE parameter configuration, and b) the respective second indication one of: i) the one or more parameters to perform the one or more application layer measurements, and ii) the report on the one or more application layer measurements.

Examples of embodiments herein may comprise signaling to the wireless device 131 information about initiation and termination of various actions or interventions performed by the RAN with respect to the wireless device 131, or with respect to the application running in the wireless device 131, or with respect to one or more data flows or data radio bearers (DRBs) pertaining to an application session in the wireless device 131, e.g., based on the received RVQoE reports in Action 203. Such information may be denoted as “assistance information”. Furthermore, the actions or interventions the assistance information may refer to may also be denoted as “assistance” or “RAN assistance”, or “RAN feedback”. Below, some different alternatives which describe the possibility to provide different levels of assistance information to the wireless device 131 or to an application in the wireless device 131 are described.

In some embodiments, at least one of the following options may apply. According to a first option, the respective first indication may be received in a first Radio Resource Control (RRC) message, e.g., in an RRCReconfiguration message. Embodiments herein may comprise sending additional information, e.g., in an RRCReconfiguration message, e.g., as part of the AppLayerMeasConfig-r17 IE, possibly included in a MeasConfigAppLayer-r17 IE in the AppLayerMeasConfig-r17 IE. The above signaling may be carried in a stand-alone RRC reconfiguration message which may carry only the above-mentioned assistance information, but the RRC reconfiguration message may also contain other information in addition to the assistance information. A typical expected use case may be that there may be an RRC message carrying reconfiguration information when it may be detected that a DASH session of the wireless device 131 may be in imminent risk of playback issues. Examples of embodiments herein may also comprise forwarding the information from the AS layer of the wireless device 131 to the application layer, e.g., by means of AT-commands. Furthermore, the proposed alternatives/options may be combined in different ways, as required by the RAN, based on the existing knowledge about the wireless device 131 and its application-level behavior.

According to a second option, the respective first indication may be comprised in a first Medium Access Control (MAC) Control Element (CE) and/or an RRC message. In addition, or as an alternative, to that RAN assistance information which a RAN node may provide to the wireless device 131 via RRC signaling, embodiments herein may comprise the sending, from the RAN node, or from an entity of a RAN node, for a gNB in split architecture the typical case may be a gNB-Distributed Unit (DU), to the wireless device 131, of RAN assistance information as MAC CE. Such information may be based for instance, on the RVQoE metrics that a gNB-DU may receive from the gNB-CU-CP, such as the “Application Layer Buffer Level List” IE included in F1AP QOE INFORMATION TRANSFER message. The MAC CE indications may indicate: 1) a scaling factor to be applied to the Recommended Bit Rate, 2) an upper bound for the bit rate, separately for UL and DL, 3) a lower bound for the bit rate, separately for UL and DL; 4) the start or stop of RAN assistance information.

In accordance with the foregoing, according to a third option, the respective first indication may be assistance information, e.g., RAN assistance information. Embodiments herein may comprise one or multiple options for RAN assistance information. In one option described here, that may be combined with one or more options detailed in this disclosure, may be including information, e.g., an optional Boolean IE as part of the RVQoE parameter configuration, that may indicate to the wireless device 131 that RAN assistance may have been activated for a session for which RVQoE reporting may have been active. This option may not divulge the specific parameters, such as expected bitrate, prioritization levels, recommended encodings to request, etc., to the wireless device 131, and may assume that the wireless device 131 may have earlier been configured by the RAN or by the application with specific guidelines to follow when RAN assistance may be active. The guidelines here may limit the highest encoding rate that the wireless device 131 application may request and force the application of the wireless device 131 to download more content, e.g., beyond its configured maximum buffer size, when the RAN assistance may be active.

In accordance with the foregoing, according to a fourth option, the first MAC CE may indicate one of: i) a scaling factor to be applied to a recommended bit rate, ii) an upper bound for the bit rate, iii) a lower bound for the bit rate, and iv) a start or a stop of a validity of the first configuration.

According to a fifth option, the respective first indication may be comprised in a first field in the first MAC CE.

According to a sixth option, the first MAC may be a Recommended bit rate MAC CE.

According to a seventh option, the first field may be a field “X”. In a possible implementation, RAN assistance information in the form of MAC CE may be realized by reusing the field “X”, Bit rate multiplier, in the existing “Recommended bit rate” MAC CE, which may point to an existing bitRateMultiplier IE specified in TS 38.331, e.g., v. 17.3.0, a bit rate multiplier for Recommended Bit rate MAC CE, and extending the bitRateMultiplier to include additional factors, e.g., extending the possible values of the IE with the addition of values indicating reductions in bitrate or multiplications of the rate to other than the current values.

According to an eighth option, the respective first indication may be comprised as a first flag in the first MAC CE, e.g., “Scale”, which may be encoded as a single bit. In another possible implementation, the “Recommended bit rate” MAC CE may be extended with new indications, such as a flag, e.g., “Scale”, which may be encoded as a single bit, which, when set to a certain value, e.g. =1, may indicate that the value of the recommended bit rate, UL or DL, may have to be scaled, e.g., multiplied, by a factor according to a new IE, e.g., a bitRateMultiplierScalingFactor-rxx IE, specified in RRC protocol specification. In one variation, the flag “Scale” in the Recommended bit rate MAC CE, when set to 1, may indicate that the value of the recommended bit rate, UL or DL, may have to be scaled and that the Bit Rate multiplier specified by bitRateMultiplier may have to not be applied.

In another alternative, an additional indication, e.g., a flag, may be used to point at an RRC parameter indicating an upper limit for the bit rate, or indicating a lower limit for the bit rate, or indicating a positive or negative offset compared to the reference bit rate or indicating a reference target, e.g., average, bit rate.

In another alternative, a new MAC CE may be introduced, and it may be used to provide to the wireless device 131 one or more of: 1) indications concerning alterations of the bit rate, in UL and/or DL, expressed in terms of minimum, maximum, average, positive or negative offsets in bit rates compared to the recommended bit rate; 2) indication of durations, e.g., in ms or seconds, of number of SFN, of such alterations; 3) initialization, e.g., start, of RAN assistance information; 4) termination, e.g., stop, of RAN assistance information.

According to a ninth option, the receiving in Action 204 may be from a Central Unit managed by the network node 110. In another alternative, also pertaining to split gNB architecture, if the DU is the entity making an RAN assistance information based on a received RVQoE report in Action 203, the DU may convey to the CU the RAN assistance information, and/or an indication about the activation/deactivation thereof, by using an existing or a newly defined F1AP message, and the CU may convey it to the wireless device 131 via RRC signaling. Similar actions may be applied in case the CU may be split into CU-CP and CU-UP. In this case, the RAN assistance information from the CU-UP may be conveyed to the wireless device 131 either directly, e.g., via F1-U signaling, in-band with user data, or first from the CU-UP to the CU-CP, via E1AP signaling, and then via RRC signaling from the CU-CP to the wireless device 131. The content of the RAN assistance information may be as defined in other sections of the present disclosure.

According to a tenth option, the respective first configuration may be an Information Element (IE) indicating a Radio Access Network (RAN) assistance supervised maximum encoding bit rate. In one option, that may be combined with one or more options detailed in this disclosure, information may be included, e.g., an optional integer IE called RAN assistance supervised max encoding bitrate, which may specify the maximum encoding rate that the application of the wireless device 131 may limit its future requests if RAN assistance is enabled. Presence of the IE may be interpreted by the wireless device 131 application as the RAN assistance being active. For this option, the RAN may not require access to the MPD, but the RAN may suggest a bitrate that may be lower than the expected download rate/throughput of the wireless device 131 by a certain factor. The application of the wireless device 131, based on the suggested value in the IE, may chose an encoding that may satisfy the constraint.

In some embodiments, the respective first indication may indicate one of the following thirteenth options.

According to a first option, the respective first indication may indicate that the respective first configuration has been activated or inactivated. A MAC CE information may be used to complement RAN assistance information sent over RRC signaling to indicate the activation or deactivation of the RAN assistance information. In this case, the RRC signaling may be used to send the RAN assistance information to the AS of the wireless device 131 and the MAC CE indications may be used to activate/terminate the use or the RAN assistance information.

According to a second option, the respective first indication may indicate that the respective first configuration has been activated or inactivated for a session.

According to a third option, the respective first indication may indicate a maximum encoding rate to be used by the wireless device 131 for the application traffic.

According to a fourth option, the respective first indication may indicate a guaranteed bit rate to be provided to the wireless device 131. In an alternative approach to other examples, the assistance information, e.g., guaranteed bitrate that the wireless device 131 may get may be determined by OAM or the core network e.g., based the subscription of the wireless device 131 or capabilities of the wireless device 131. The assistance information may in such case be included within the QoE configuration file provided by OAM. In this approach, the network node 110 may need to fulfil the requirements that OAM or the core network may have decided, e.g., based on the subscription of the wireless device 131 or capabilities of the wireless device 131. The network node 110 may receive the requirements for the specific wireless device 131 or a group of UEs such as the one or more wireless devices 131, 132 from OAM or from the core network.

The received respective first indication may be based on the sent respective first previous indication in Action 201.

In one option, that may be combined with one or more options detailed in this disclosure, where the RAN as part of the RVQoE configuration in an RRC reconfiguration message may inform the wireless device 131 of the guaranteed bitrate that may be provided to the wireless device 131. The application of the wireless device 131 may interpret the absence of this IE as an indication that the UE may be prioritized without a guaranteed bitrate, i.e., the other IEs indicating RAN assistance, e.g., RANAssistanceActive, or RANAssistanceSupervisedEncodingBitrate may indicate that the RAN may be prioritizing the application of the wireless device 131 without a guaranteed bitrate configuration.

According to a fifth option, the respective first indication may indicate, whether the guaranteed bit rate is a minimum guaranteed bit rate, an average bit rate or a maximum bit rate. In one option, that may be combined with one or more options detailed in this disclosure, as an extension to the fourth option that e.g., may indicate if the guaranteed bitrate may be the minimum guaranteed bitrate, an average bitrate or the maximum guaranteed bitrate, wherein a maximum guaranteed bitrate may imply a bitrate cap or bitrate limit enforced by the RAN.

According to a sixth option, the respective first indication may indicate a condition the first configuration may be subject to.

According to a seventh option, the respective first indication may indicate that the respective first configuration is to be provided at a future timepoint, upon fulfilment of the condition.

In an alternative, the wireless device 131 may be informed that it may be supplied with RAN assistance information, e.g., in a certain time or upon fulfilment of specific events such as the time of a handover execution, in this case, for instance the RAN assistance information may be conveyed as part of the handover command sent to the wireless device 131, or upon completion of a procedure reconfiguring the wireless device 131 from single connectivity to multi-connectivity, or vice versa, or upon transition from RRC_INACTIVE state to RRC_CONNECTED state, or upon transition from RRC_IDLE state to RRC_CONNCETED state, or upon transition from RRC_CONNECTED to one of RRC_INACTIVE state or RRC_IDLE state.

In the absence of an explicit indication from the RAN of a condition for when the RAN assistance may cease, the wireless device 131, or the concerned application in the wireless device 131, e.g., the application the RAN assistance information pertains to or the application who's associated RVQoE report(s) triggered the RAN assistance information, may assume a default condition to apply. The default condition may be a certain specified or preconfigured time duration or any one of the listed conditions in this disclosure, e.g., above. The default condition above may be interpreted by the wireless device 131 either through dedicated signaling or via the presence or absence of other assistance indications from the RAN. In one option, that may be combined with one or more options detailed in this disclosure, which may correspond to the state where no RAN assistance may be activated, which may either be indicated explicitly by negating any previously applied configurations or through none of the e.g., above, specified optional configuration parameters being present in the signaling. In one option, that may be combined with one or more options detailed in this disclosure, may be that RAN assistance information provided to an application in the wireless device 131 may be implicitly or explicitly indicated as being active until a condition may be fulfilled, where the condition may be expressed in terms of one or more reported RVQoE metrics or RVQoE value, e.g., in relation to a threshold. As an example, RAN assistance information indicating that a UE, or the data flows of a DASH application session in the wireless device 131, or any other type of application using a buffer, e.g., a playout buffer, may be given higher scheduling priority, and/or higher bitrate, may be valid until the application may report, in a RVQoE report, a buffer level that may above a certain threshold, where the threshold may be an absolute threshold, e.g. expressed in terms of playout time, or a relative threshold, e.g., expressed as a fraction of full buffer or a fraction of a certain buffer level where the application client may temporarily stop requesting more media data from the media server, and where the threshold may be indicated as a part of the RAN assistance information, or may be specified in a standard. The received respective first indication may be based on the indicated application in Action 202. In one option, RAN may signal the RAN assistance information based on information received from the wireless device 131, e.g., that a certain application may be used in the wireless device 131, as performed in a non-published internal reference implementation, where the wireless device 131 may send an application identifier to the network. This may be relevant in case of applications requiring special network conditions, e.g., URLLC applications.

According to an eighth option, the respective first indication may indicate the condition the respective first configuration may be subject to, wherein the condition is other prioritized traffic at the network node 110. In one option, that may be combined with one or more options detailed in this disclosure, where the RAN may indicate to the wireless device 131 if the RAN assistance may be conditional on other prioritized traffic being carried on the network, e.g., an indication if the RAN assistance may cease or deviate from the suggested parameters when the network may encounter competing traffic from other prioritized flows, such as data flows pertaining to URLLC UEs or URLLC applications, or overload, in case of overload in the network, an indication of overload from the RAN to the wireless device 131 may be needed.

According to a ninth option, the respective first indication may indicate that a resource allocated to the wireless device 131 is e.g., temporarily, reduced.

According to a tenth option, the respective first indication may indicate that the resource allocated to the wireless device 131 is e.g., temporarily, increased.

According to an eleventh option, the respective first indication may indicate a time period during which the respective first configuration is to remain active; for example, until an RRC reconfiguration message is received without any RAN assistance parameter(s); Examples of other conditions will be provided later on. In one option, that may be combined with one or more options detailed in this disclosure, which may indicate to the wireless device 131 about the time-period for which RAN assistance may be active in a specified time unit, e.g., milliseconds/seconds.

According to a twelfth option, the respective first indication may indicate one or more conditions for the respective first configuration to remain active. The one or more conditions may comprise for example, one or more reported RVQoE metrics or RVQoE value, e.g., in relation to a threshold.

According to a thirteenth option, the respective first indication may indicate a cancellation of a previously provided respective first configuration.

Alternative conditions for how long the RAN assistance may be active, or for when it may cease may include, e.g., that the RAN assistance may be active . . . : a) until an RRC reconfiguration message is received without any RAN assistance parameter(s), or, b) until an RRC reconfiguration message is received which includes the AppLayerMeasConfig-r17 IE, but where the AppLayerMeasConfig-r17 IE does not contain any MeasConfigAppLayer-r17 IE pertaining to the concerned application, where the concerned application may be indicated by the MeasConfigAppLayerId-r17 IE associated with the QoE/RVQoE configuration associated with the concerned application, or c) until an RRC reconfiguration message is received which includes the AppLayerMeasConfig-r17 IE which includes a MeasConfigAppLayer-r17 IE pertaining to the concerned application, where the concerned application may be indicated by the MeasConfigAppLayerId-r17 IE associated with the QoE/RVQoE configuration associated with the concerned application, but where this MeasConfigAppLayer-r17 IE may not contain any RAN assistance information, or may contain another type of assistance information, or d) until an RRC reconfiguration message is received with an explicit indication that the RAN will cease to apply the previously indicated intervention, or e) until an RRC Reconfiguration procedure or an RRC Resume procedure is completed; the time until which RAN assistance information may be applicable may be implicitly specified; for example, the wireless device 131 may implicitly assume that RAN assistance information is valid until the wireless device 131 may have successfully performed a Reconfiguration with Synch towards a cell that may be the target cell of a handover, or until it may be successfully added a cell as Secondary Cell (Scell) or Primary Secondary Cell (PSCell), or until the time at which an SCell/PSCell may no longer be in use, f) until the full content or a certain, explicitly indicated amount of data, has been downloaded, or g) until the wireless device 131 may indicate to the network node 110 that the full content has been downloaded, or h) until the end of the concerned application session, or i) until the application may send a session end indication to the RAN, e.g., via the AS of the wireless device 131, j) until the present session is paused in the wireless device 131, e.g., by the user, k) until a condition expressed in terms of one or more reported RVQoE metrics or RVQoE value is fulfilled, see the conditional option below; l) as long as the wireless device 131 may be within a certain area, e.g., in certain cell(s), certain Tracking Area, certain Public Land Mobile Network (PLMN) or other indication of area, m) as long as a certain application or a service type is used in the wireless device 131, n) as long as the wireless device 131 is in a certain mobility state, e.g., static, moving faster or slower than a certain speed, o) As long as the wireless device 131 is in a certain connectivity setup, e.g., dual- or single-connectivity.

Table 1 shows a non-limiting example of the respective first indication and the respective second indication. Particularly, Table 1 shoes an RRC signalling, according to TS 38.331, e.g., v. 17.3.0, example of signaling of RAN assistance information to the wireless device 131 using RAN-VisibleParameters IE.

TABLE 1
-- ASN1START
-- TAG-APPLAYERMEASCONFIG-START

| | |
|---|---|
| AppLayerMeasConfig-r17 ::= | SEQUENCE { |

| | |
|---|---|
| measConfigAppLayerToAddModList-r17 | SEQUENCE (SIZE (1..maxNrofAppLayerMeas- |

| | |
|---|---|
| r17)) OF MeasConfigAppLayer-r17 | OPTIONAL, -- Need N |

| | |
|---|---|
| measConfigAppLayerToReleaseList-r17 | SEQUENCE (SIZE (1..maxNrofAppLayerMeas- |

| | |
|---|---|
| r17)) OF MeasConfigAppLayerId-r17 | OPTIONAL, -- Need N |

| | |
|---|---|
| rrc-SegAllowed-r17 | ENUMERATED {enabled} |

OPTIONAL, -- Need R
...
}

| | |
|---|---|
| MeasConfigAppLayer-r17 ::= | SEQUENCE { |

| | |
|---|---|
| measConfigAppLayerId-r17 | MeasConfigAppLayerId-r17, |

| | |
|---|---|
| measConfigAppLayerContainer-r17 | OCTET STRING (SIZE (1..8000)) |

OPTIONAL, -- Need N

| | |
|---|---|
| serviceType-r17 | ENUMERATED {streaming, mtsi, vr, spare5, spare4, spare3, |

spare2, spare1} OPTIONAL, -- Need M

| | |
|---|---|
| pauseReporting-r17 | BOOLEAN |

OPTIONAL, -- Need M

| | |
|---|---|
| transmissionOfSessionStartStop-r17 | BOOLEAN |

OPTIONAL, -- Need M

| | |
|---|---|
| ran-VisibleParameters-r17 | SetupRelease {RAN-VisibleParameters-r17} |

OPTIONAL, -- Cond ServiceType
...
}

| | |
|---|---|
| RAN-VisibleParameters-r17 ::= | SEQUENCE { |
| ran-VisiblePeriodicity-r17 | ENUMERATED {ms120, ms240, ms480, ms640, ms1024} |

OPTIONAL, -- Need S

| | |
|---|---|
| numberOfBufferLevelEntries-r17 | INTEGER (1..8) |

OPTIONAL, -- Need R
reportPlayoutDelayForMediaStartup-r17 BOOLEAN
OPTIONAL, -- Need M

| | |
|---|---|
| RANAssistanceIndication ::= | SEQUENCE { |

| | |
|---|---|
| RANAssistanceActive | BOOLEAN |

```
    OPTIONAL,
        RANAssistanceSupervisedMaxEncodingBitrate INTEGER
    OPTIONAL,
```

| | |
|---|---|
| RANAssistanceGuaranteedBitrate | INTEGER |

OPTIONAL,

| | |
|---|---|
| RANAssistanceBitrateMin | BOOLEAN |

OPTIONAL,

| | |
|---|---|
| RANAssistanceBitrateMax | BOOLEAN |

OPTIONAL,

| | |
|---|---|
| RANAssistanceStatusDuringOverload | BOOLEAN |

```
    OPTIONAL,
        RANAssistanceDuration INTEGER (0..30000)
    OPTIONAL,
```

| | |
|---|---|
| RANAssistanceTerminationIndication ::= | SEQUENCE { |

| | |
|---|---|
| AppLayerBufferLevelThreshold | INTEGER |

```
        OPTIONAL,
      }
        QoEDegradationDueToRANExternalFactors BOOLEAN
    OPTIONAL,
    }
  ...
}
-- TAG-APPLAYERMEASCONFIG-STOP
-- ASN1STOP
```

The received respective first indication may be based on the sent respective third previous indication in Action 203. The RAN, when receiving RVQoE reports from the application of the wireless device 131 that may indicate imminent QoE degradations, may evaluate the source of the bottleneck in the delivery network by associating the reports of the wireless device 131 with the observed behavior on the transport network link leading up to the RAN, e.g., the rate of packet arrival for that wireless device 131/flow to the RAN and the rate at which the packets may be successfully delivered to the wireless device 131, and other associated metrics. By analyzing the behavior in the different hops, the RAN many also determine that the radio link may not be the bottleneck for the wireless device 131 session being observed, e.g., if the RAN is able to deliver the packets to the wireless device 131 in the same rate as they arrive to the RAN. In such cases, RAN's intervention may not achieve any meaningful improvements to the end-user QoE and the RAN may therefore not attempt any actions. The RAN may also choose to indicate this to the wireless device 131/the application, as this information may be useful feedback to the application provider, signaling indicated as part of Table 1, QoEDegradationDueToRANExternalFactors. How this information may be carried to the application provider is out of scope of this disclosure.

In some embodiments, the respective first indication may indicate that the resource allocated to the wireless device 131 may be temporarily reduced. In some of these embodiments, the respective first indication may comprise at least one IE indicating at least one of: a) QoS reduction is underway and b) one or more parameters the application may have to abide by; in some of these embodiments, the one or more parameters may be selected from: i) RANInitiatedQoSReduction, ii) RANInitiatedQoSReductionDuration, and iii) RANInitiatedQoSReductionMaxEncoding rate.See Table 2 and related description for further details and examples.

In some examples, there may be an impact of RAN assistance on unassisted UEs/UE applications: In another alternative, the RAN may have to balance out the assistance provided to a certain DASH UE application session, e.g., an application session of the first wireless device 131, by temporarily decreasing one or more QoS parameters provided to other DASH UE application sessions, e.g., of the other wireless devices 132, for example under high load, or when other non-DASH UE's QoS may not be altered. In such scenarios, the RAN may also indicate to a certain UE, e.g., the wireless device 131, that may have, for example, a high buffer, high playback quality, that it may be temporarily decreasing the resource allocated to that wireless device 131 or an associated application session, and optionally that the wireless device 131 may have to not react to the temporary reduction of the available bandwidth by choosing lower encodings for future video chunks. The table below, Table 2, shows an example ASN. 1 realization where the RAN communicates to a temporarily deprioritized UE. Particularly, Table shows a non-limiting example of the respective first indication as ssignalling of RAN assistance information, where the wireless device 131 is down prioritized, to the wireless device 131 using RAN-VisibleParameters IE.

TABLE 2
-- ASN1START
-- TAG-APPLAYERMEASCONFIG-START

| | |
|---|---|
| AppLayerMeasConfig-r17 ::= | SEQUENCE { |

| | |
|---|---|
| measConfigAppLayerToAddModList-r17 | SEQUENCE (SIZE (1..maxNrofAppLayerMeas- |

| | |
|---|---|
| r17)) OF MeasConfigAppLayer-r17 | OPTIONAL, -- Need N |

| | |
|---|---|
| measConfigAppLayerToReleaseList-r17 | SEQUENCE (SIZE (1..maxNrofAppLayerMeas- |

| | |
|---|---|
| r17)) OF MeasConfigAppLayerId-r17 | OPTIONAL, -- Need N |

| | |
|---|---|
| rrc-SegAllowed-r17 | ENUMERATED {enabled} |

OPTIONAL, -- Need R
...
}

| | |
|---|---|
| MeasConfigAppLayer-r17 ::= | SEQUENCE { |

| | |
|---|---|
| measConfigAppLayerId-r17 | MeasConfigAppLayerId-r17, |

measConfigAppLayerContainer-r17 OCTET STRING (SIZE (1..8000))
OPTIONAL, -- Need N

| | |
|---|---|
| serviceType-r17 | ENUMERATED {streaming, mtsi, vr, spare5, spare4, spare3, |

spare2, spare1} OPTIONAL, -- Need M

| | |
|---|---|
| pauseReporting-r17 | BOOLEAN |

OPTIONAL, -- Need M
transmissionOfSessionStartStop-r17 BOOLEAN
OPTIONAL, -- Need M

| | |
|---|---|
| ran-VisibleParameters-r17 | SetupRelease {RAN-VisibleParameters-r17} |

OPTIONAL, -- Cond ServiceType
...
}

| | |
|---|---|
| RAN-VisibleParameters-r17 ::= | SEQUENCE { |
| ran-VisiblePeriodicity-r17 | ENUMERATED {ms120, ms240, ms480, ms640, ms1024} |

OPTIONAL, -- Need S

| | |
|---|---|
| numberOfBufferLevelEntries-r17 | INTEGER (1..8) |

OPTIONAL, -- Need R
reportPlayoutDelayForMediaStartup-r17 BOOLEAN
OPTIONAL, -- Need M

| | |
|---|---|
| RANAssistanceIndication ::= | SEQUENCE { |

| | |
|---|---|
| RANInitiatedQoSReduction | BOOLEAN |

OPTIONAL,

| | |
|---|---|
| RANInitiatedQoSReductionDuration | INTEGER (0..30000) |

OPTIONAL,

| | |
|---|---|
| RANInitiatedQoSReductionMaxEncodingBitrate | INTEGER |

```
    OPTIONAL,
    }
  ...
}
-- TAG-APPLAYERMEASCONFIG-STOP
-- ASN1STOP
```

### Action 205

In this Action 205, the wireless device 131 may receive a respective third indication.

The receiving in this Action 205 may be from the network node 110.

The receiving in this Action 205 may be performed, e.g., via the first link 141.

In some embodiments, the receiving in this Action 205 of the respective third indication from the network node 110 may be based on the received respective first indication.

The respective third indication may indicate a respective second configuration of radio resources. In another alternative of examples herein, in addition to providing assistance information to the wireless device 131 based on the received RVQoE reports, the RAN may also want to change the radio configuration for the wireless device 131 whereby the component carrier configuration, dual-connectivity configuration, or other radio and node configuration may be altered in accordance with predefined procedures.

In some embodiments, at least one of the following may apply: a) the respective third indication may be received in a second RRC message, b) the respective third indication may be comprised in a second MAC CE message, and c) the second MAC CE may indicate a start or a stop of the validity of the respective first indication.

Interaction with Radio and Minimization of Drive Test (MDT) Measurements

In one alternative realization of the approaches described above, either upon receiving RVQoE measurement reports or other measurement reports characterizing the perceived Access Stratum from the perspective of the wireless device 131, such as radio layer measurements on RSRP, RSRQ, Quality of Service (RSSI), Packet Data Convergence Protocol (PDCP) Service Data Unit (SDU) delay measurements, etc., the RAN node may: a) perform either an RVQoE-based intervention or radio layer reconfigurations towards the wireless device 131 that signalled the above measurements and/or b) signal RVQoE-based intervention or radio layer reconfigurations towards another UE(s), e.g., the other wireless devices 132, that may be affected by the planned RAN intervention or the planned radio reconfiguration.

In the above, the RAN node may determine/decide the intervention based on the RVQoE and/or AS reports received from the wireless device 131 subject to intervention and/or reconfiguration, and/or such reports received from one or more other UEs, e.g., the other wireless devices 132. The signaling may include an initial indication or a modification of one or more RAN assistance actions or perform radio resource reconfiguration in addition to initiation or modification of RVQoE-based RAN assistance intervention. The radio layer measurements may be leveraged by the RAN to estimate if certain planned actions, such as RAN assistance, may indeed benefit the same wireless device 131 reporting the measurements, depending on the radio coverage, radio quality, or other radio-layer characteristics measured by the wireless device 131 that may be used to infer properties of the RAN. Upon receiving indications from the wireless device 131 that the radio layer characteristics are poor, or better than expected, the RAN may perform additional resource optimization and/or allocation and/or deallocation at the radio layer towards the other wireless devices 132 or towards the wireless device 131 that signalled the measurements to improve the QoE/RVQoE application measurement results, e.g., to achieve the target application-level QoE.

In another realization, the RAN node may use radio measurements collected as part of MDT to initiate or modify RAN intervention actions. In addition, alignment between radio measurements and RVQoE measurements may further be utilized by the RAN node to aid in planning and execution of RAN intervention and other configuration changes that the intervention may bring about, such as UE reconfiguration.

### Additional Variations

In the approach as disclosed according to the options described above, the RAN assistance information may be targeting a single UE, the wireless device 131, and dedicated signaling may be used. In a possible variation of the embodiments herein, the RAN may determine to provide the RAN assistance information for a group of UE, e.g., the one or more wireless devices 131, 132, at the same time. For example, the RAN node may send in a System Information message, one or more of the RAN assistance information described above, together with an identifier that may identify the group of UEs targeted by the RAN assistance information, e.g., for a Broadcast service, it may be the identifier of a MBS Session, as a Temporary Mobile Group Identity (TMGI). A UE receiving the System Information message may determine whether the RAN assistance information may be targeting itself checking whether the group identifier comprised in the System Information may be the same as the identifier of the group to which the wireless device 131 may belong to. If the check is positive, the wireless device 131 may take the RAN assistance information into account.

A group(s) of UEs such as the one or more wireless devices 131, 132 may also be targeted in dedicated signaling, where UEs belonging to the group may receive the same RAN assistance information in a dedicated signaling such as an RRCReconfiguration message. The group of UEs may e.g., be UEs belonging to the same area, UEs belonging to certain non-public network (NPN) or UEs with certain subscription. The assistance information may also be included in the QoE configuration file as listed in one option above.

In another alternative, pertaining to a group of UEs such as the one or more wireless devices 131, 132 served by a node, such as the network node 110, in split gNB architecture, if the DU is the entity making an intervention based on a received RVQoE report, the DU may convey to the CU the RAN assistance information for a group of UEs, e.g., the one or more wireless devices 131, 132, and/or an indication about the activation/deactivation thereof, by using an existing or a newly defined F1AP message. In one alternative, a non-UE-associated message may be used to convey the RAN assistance information pertaining to a group of UEs such as the one or more wireless devices 131, 132. In another alternative, the RAN assistance information pertaining to a group of UEs may be transferred from the DU to the CU, in multiple messages, each message carrying the RAN assistance information being a UE-associated message.

Upon reception of the RAN assistance information at the CU, the CU may convey it to the group of UEs such as the one or more wireless devices 131, 132, either within a System Information message, as previously described, or individually to each UE, via RRC signaling. Similar actions may be applied in case the CU may be split into CU-CP and CU-UP—in this case, the RAN assistance information from the CU-UP may be conveyed to the group of UEs such as the one or more wireless devices 131, 132 either directly, e.g., via F1-U signaling, in-band with user data, or first from the CU-UP to the CU-CP, via E1AP signaling, and then via RRC signaling from the CU-CP to the group of UEs. The content of the RAN assistance information may be as defined in other sections of the present disclosure. In the above, it may be assumed that the RAN assistance information for a single group of UEs may be delivered with an F1AP/E1AP message. In another alternative, RAN assistance information pertaining to multiple groups of UEs may be delivered to the CU in the same message.

### Action 206

Upon reception of the messages, e.g., from Action 204 and/or Action 205, from the RAN by the AS of the wireless device 131, this message may be sent to the application. This may be achieved by extending the +CAPPLEVMCNR message, or a newly defined message, to include the indication about RAN assistance to the application. Below the approaches describing the different alternatives mentioned above and how this may be communicated to the application are described in further detail.

+CAPPLEVMCNR: (list of [<CR><LF>,<meas_config_app_layer_id>,[<start-
stop_measurement>,[<ran_visible_release_only>]],[<app-meas_config_file_length>,<app-
meas_config-file>],[<transmission_of_session_start-
end>],[<ran_visible_periodicity>],[<number_of_buffer_level_entries>],[<report_initial_playout_{—}
delay>],[<app-
meas_service_type>],[<ran_assistance_active>],[<ran_assistance_supervised_max_encoding
_bitrate>],[<ran_assistance_guaranteed_bitrate>],[<ran_assistance_bitrate_min>],[<ran_assist
ance_bitrate_max>],[<ran_assistance_status_during_overload>],[<ran_assistance_duration>],
[<qoe_degradation_due_to_ran_external_factors>],[<ran_initiated_qos_reduction>],[<ran_initi
ated_qos_reduction_duration>],[< ran_initiated_qos_reduction_max_encoding_bitrate>]]s)

When the application may receive the indications, the choice of the encoding chosen for next video chunks/segments may be regulated in accordance to one or more values specified as part of the different IEs, e.g., by either choosing the closest encoding that may be equal to or lower than the specified value or by thresholds that may be available internally either as a default configuration available at the application, or specified separately as part of the MPD, via the RAN, or by choosing a conservative value based on the relationship between the encodings available in the MPD and the screen dimensions. In addition, the choice of the chosen encoding may also be regulated in accordance with the time for which RAN assistance may be specified to be active, and in this case, the application layer may attempt to download enough content at the certain encoding rate such that the buffer filled at the end of the RAN assistance duration.

In cases when the application may be made aware that the QoS reduction may be due to the RAN prioritizing other UEs such as the other wireless devices 132, the application layer may discard the throughput estimates computed during this period, and/or request future chunks at a rate that may have been specified by the RAN, either implicitly or explicitly or continue downloading chunks at the same encoding as the previous throughput estimates suggest.

In this Action 206, the wireless device 131 sends a respective application layer measurement report.

The sending in this Action 206 may be, e.g., to the network node 110.

The sending in this Action 206 may be, e.g., transmitting, and may be performed, e.g., via the first link 141.

The sending in this Action 206 of the respective application layer measurement report may be based on the indicated respective first configuration.

In some embodiments, applying of the received first configuration to the respective application layer measurement report may be subject to the fulfilment of the condition.

In some embodiments, the received respective second configuration in Action 205 may be applied to the sent respective application layer measurement report in this Action 206.

In some examples, at least one of the following may apply: a) the respective first indication may be received in the first RRC message, b) the respective first indication may be comprised in the first MAC CE in the RRC message, c) the respective first indication may be assistance information, d) the first MAC CE may indicate one of: i) the scaling factor to be applied to the recommended bit rate, ii) the upper bound for the bit rate, iii) the lower bound for the bit rate, and iv) the start or a stop of the validity of the first configuration, v) the respective first indication may be comprised in the first field in the first MAC CE, vi) the first MAC may be is the Recommended bit rate MAC CE, vii) the first field may be the field “X”, viii) the respective first indication may be comprised as the first flag in the first MAC CE, ix) the receiving in Action 204 may be from the Central Unit managed by the network node 110, x) the respective first configuration may be the IE indicating the RAN assistance supervised maximum encoding bit rate, and xi) the sending in Action 206 of the respective application layer measurement report may be to the network node 110.

In some embodiments, the wireless device 131 may perform Action 204 and Action 206. In some embodiments, the method may further comprise one or more of Action 201, Action 202 and Action 203, e.g., before receiving the respective first indication. In some embodiments, the method may further comprise Action 205.

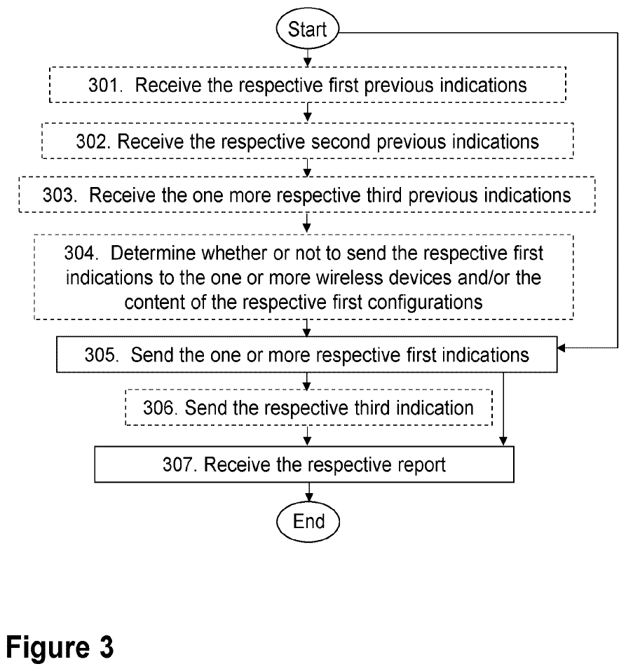

Embodiments of a method, performed by a network node, such as the network node 110 will now be described with reference to the flowchart depicted in FIG. 3. The method may be understood to be for handling the one or more application layer measurements. The network node 110 operates in a wireless communications network, such as the wireless communications network 100. The method may be understood to be computer-implemented.

In some embodiments, the wireless communications network 100 may support New Radio (NR).

The method may comprise one or more of the following actions. In some embodiments, all the actions may be performed. It should be noted that the examples herein may be not mutually exclusive. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the network node 110 is depicted in FIG. 3. In FIG. 3, optional actions in some embodiments may be represented with dashed lines. In some embodiments, the actions may be performed in a different order than that depicted FIG. 3.

The detailed description of some of the following corresponds to the same references provided above, in relation to the actions described for the wireless device 131 and will thus not be repeated here to simplify the description. For example, the respective first indication may be RAN assistance information.

### Action 301

In this Action 301, the network node 110 may receive the respective first previous indication.

The receiving in this Action 301 may be from the one or more wireless devices 131, 132.

The receiving in this Action 301 may be performed, e.g., via the first link 141 and/or the respective other links.

The first previous indication may indicate the one or more respective capabilities of the respective one or more wireless devices 131,132.

### Action 302

In this Action 302, network node 110 may receive the respective second previous indication.

The receiving in this Action 302 may be from the one or more wireless devices 131, 132.

The receiving in this Action 302 may be performed, e.g., via the first link 141 and/or the respective other links.

The second previous indication may indicate a respective application used by the respective one or more wireless devices 131,132.

### Action 303

In this Action 303, the network node 110 may receive the one or more respective third previous indications.

The receiving in this Action 303 may be from the one or more wireless devices 131, 132 operating in the wireless communications network 100.

The receiving in this Action 303 may be performed, e.g., via the first link 141 and/or the respective other links.

The one or more respective third previous indications may indicate the one or more respective measurements respectively performed by the one or more wireless devices 131,132. The one or more respective measurements may comprise at least one of: application layer measurements and radio layer measurements.

The respective third previous indication may be the RVQoE report.

### Action 304

In this Action 304, the network node 110 may determine whether or not to send the respective first indications to the one or more wireless devices 131,132 and/or a respective content of the respective first configurations.

In some embodiments, the network node 110 may determine whether or not to send the respective first indications to the one or more wireless devices 131,132 and the respective content of the respective first configurations.

Determining may be understood as deciding, selecting, or similar.

The determining in this Action 304 may be based on at least one of the received respective first previous indication, respective second previous indication and one or more respective third previous indications.

The determining in this Action 304 may be alternatively or additionally based on a load of the RAN, e.g., of the network node 110, and/or characteristics of traffic on the RAN, e.g., on the network node 110.

The determining in this Action 304 may be alternatively or additionally based on other factors.

As stated earlier, in an alternative approach to other examples, the assistance information, e.g., guaranteed bitrate that the wireless device 131 may get may be determined by OAM or the core network e.g., based the subscription of the wireless device 131 or capabilities of the wireless device 131. The assistance information may in such case be included within the QoE configuration file provided by OAM. In this approach, the network node 110 may need to fulfil the requirements that OAM or the core network may have decided, e.g., based on the subscription of the wireless device 131 or capabilities of the wireless device 131. The network node 110 may receive the requirements for the specific wireless device 131 or a group of UEs such as the one or more wireless devices 131, 132 from OAM or from the core network.

Also as stated earlier, the RAN, when receiving RVQoE reports from the application of the wireless device 131 that may indicate imminent QoE degradations, may evaluate the source of the bottleneck in the delivery network by associating the reports of the wireless device 131 with the observed behavior on the transport network link leading up to the RAN, e.g., the rate of packet arrival for that wireless device 131/flow to the RAN and the rate at which the packets may be successfully delivered to the wireless device 131, and other associated metrics. By analyzing the behavior in the different hops, the RAN many also determine that the radio link may not be the bottleneck for the wireless device 131 session being observed, e.g., if the RAN is able to deliver the packets to the wireless device 131 in the same rate as they arrive to the RAN. In such cases, RAN's intervention may not achieve any meaningful improvements to the end-user QoE and the RAN may therefore not attempt any actions. The RAN may also choose to indicate this to the wireless device 131/the application, as this information may be useful feedback to the application provider, signaling indicated as part of Table 1, QoEDegradationDueToRANExternalFactors.

### Action 305

In this Action 305, the network node 110 may send the one or more respective first indications.

The sending in this Action 305 may be to at least one wireless device 131 of the one or more wireless devices 131, 132, that is, to the wireless device 131.

Each of the one or more respective first indications indicates: a) a respective first configuration of a respective second indication of the one or more respective application layer measurements, and b) that the respective first configuration is based on the one or more respective measurements, by the wireless device 131 or other wireless devices 132. The one or more respective measurements comprise at least one of: application layer measurements and radio layer measurements.

The one or more respective measurements may comprise at least one of: application layer measurements and radio layer measurements received in the one or more respective third indications.

In some examples, the network node 110 may send the one or more respective first indications to the one or more wireless devices 131, 132 at the same time, for example, as a group, e.g., via a System Information message, or a dedicated message.

The sending in this Action 302 may be performed, e.g., via the first link 141 and/or the respective other links.

The sent respective first indications may be based on the received respective previous indications.

The sent respective first indications may be based on a result of the determination in Action 304.

The network node 110 may receive the respective first previous indication in Action 301 before sending the respective first indication in this Action 305.

The network node 110 may receive the respective second previous indication in Action 302 before sending the respective first indication in this Action 305.

The network node 110 may receive the one or more respective third previous indications in Action 303 before sending the respective first indication in this Action 305.

The sent respective first indications in this Action 305 may be based on the indicated respective application in Action 302.

The network node 110 may receive the respective second previous indication in Action 302 before sending the respective first indication in this Action 305.

The sent respective first indications in this Action 305 may be based on the received respective third previous indications in Action 305.

### Action 306

In this Action 306, the network node 110 may send the respective third indication.

The sending in this Action 306 may be to the one or more wireless devices 131,132.

The sending in this Action 306 may be performed, e.g., via the first link 141 and/or the respective other links.

The sending in this Action 306 of the respective third indication may be based on the sent respective first indications. The respective third indications may indicate a respective second configuration of radio resources.

In some examples, at least one of the following may apply: a) the respective third indication may be sent in a second RRC message, b) the respective third indication may be comprised in a second MAC CE message, and c) the second MAC CE may indicate a start or a stop of the validity of the respective first indication.

### Action 307

In this Action 307, the network node 110 may receive the respective application layer measurement report.

The receiving in this Action 307 may be from the wireless device 131 based on the indicated respective first configuration.

In some examples, the receiving in this Action 307 may comprise receiving respective application layer measurement reports from several of the one or more wireless devices 131, 132.

The receiving in this Action 307 may be performed, e.g., via the first link 141 and/or the respective other links.

In some examples, at least one of the following may apply: a) the respective first configuration may be a RVQoE parameter configuration, and b) the respective second indication may be one of: i) one or more parameters to perform the one or more respective application layer measurements, and ii) a report on the one or more application layer measurements.

In some examples, at least one of the following may apply: a) the respective first indication may be sent in an RRC message, b) the respective first indication may be comprised in a first MAC CE and/or in an RRC message, c) the respective first indication may be assistance information, d) the first MAC CE may indicate one of: i) a scaling factor to be applied to a recommended bit rate, ii) an upper bound for the bit rate, iii) a lower bound for the bit rate, iv) a start or a stop of a validity of the first configuration, e) the respective first indication may be comprised in the first field in the first MAC CE, f) the first MAC CE may be a Recommended bit rate MAC CE, g) the first field may be a field “X”, h) the respective first indication may be comprised as a first flag in the first MAC CE, i) the sending in Action 305 may be by a Central Unit managed by the network node 110, and j) the respective first configuration may be an IE indicating a RAN assistance supervised maximum encoding bit rate.

In some examples, the respective first indication may indicate one of the following: a) that the respective first configuration has been activated or inactivated, b) that the respective first configuration has been activated or inactivated for a session, c) the maximum encoding rate to be used by the wireless device 131 for the application traffic, d) the guaranteed bit rate to be provided to the wireless device 131, e) whether the guaranteed bit rate is the minimum guaranteed bit rate, the average bit rate or the maximum bit rate, f) the condition the first configuration is subject to, g) that the respective first configuration is to be provided at a future timepoint, upon fulfilment of the condition, h) the condition the respective first configuration may be subject to, wherein the condition may be other prioritized traffic at the network node 110, i) that the resource allocated to the wireless device 131 is temporarily reduced, j) that the resource allocated to the wireless device 131 is temporarily, increased, k) the time period during which the respective first configuration is to remain active, I) the one or more conditions for the respective first configuration to remain active, and m) the cancellation of the previously provided respective first configuration.

In some embodiments, the application of the sent respective first configuration to the application layer measurement report may be subject to the fulfilment of the condition.

In some examples, the respective first indication may indicate that the resource allocated to the wireless device 131 may be e.g., temporarily reduced. In some of these examples, the respective first indication may comprise at least one IE indicating at least one of: a) QoS reduction is underway and b) one or more parameters the application may have to abide by; the one or more parameters may be selected from: i) RANInitiatedQoSReduction, ii) RANInitiatedQoSReductionDuration, and iii) RANInitiatedQoSReductionMaxEncoding rate.

The received respective application layer measurement report may be based on the sent respective second configuration in Action 306.

In some embodiments, the wireless device 131 may perform Action 305 and Action 307. In some embodiments, the method may further comprise one or more of Action 301, Action 302 and Action 303, e.g., before sending the respective first indication. In some embodiments, the method may further comprise Action 303.

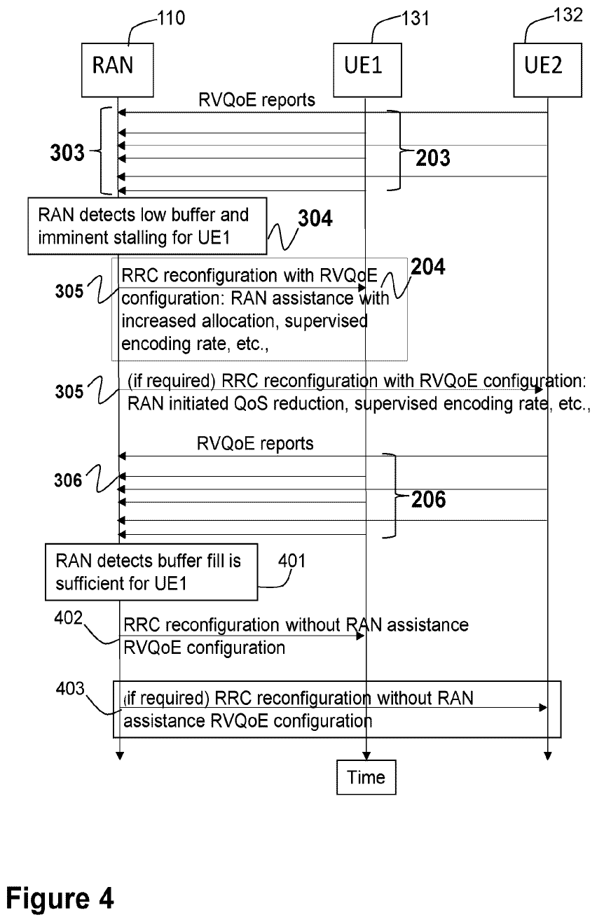

FIG. 4 is a schematic diagram depicting a non-limiting example of a signaling overview according to embodiments herein. In this example, the first wireless device 131 is depicted as UE 1. The wireless communications network 100 comprises another wireless device 132, depicted as UE2. The network node 110 is indicated as RAN. According to Action 203 and Action 303, the network node 110 receives the respective first previous indications from the one or more wireless devices the one or more devices 131, 132 comprising respective RVQoE reports. The network node 110, according to Action 304 detects low buffer and imminent stalling for the wireless device 131, UE1. According to Action 305 and Action 204, the network node 110 then sends the respective first indication to the wireless device 131 indicating a RRC reconfiguration with RVQoE configuration as RAN assistance with increased allocation, supervised encoding rate, etc., If required, also in accordance with Action 305, the network node 110 may also send the respective first indication to the another wireless device 132 comprising a respective RRC reconfiguration with RVQoE configuration, e.g., RAN initiated QoS reduction, supervised encoding rate, etc., The one or more wireless devices 131, 132 then send, according to Action 206 and Action 306, the respective application layer measurement report, RVQoE reports, based on the indicated respective first configuration. At 401, the network node 110 detects the buffer fill is sufficient for UE 1. At 402, the network node 110 then sends to the wireless device 131 an RRC reconfiguration without RAN assistance RVQoE configuration. At 403, if required, the network node 110 may also send an RRC reconfiguration without RAN assistance RVQoE configuration to the another wireless device 132.

Certain embodiments disclosed herein may provide one or more of the following technical advantage(s), which may be summarized as follows.

Embodiments herein may enable tighter coordination between the RAN and the applications running at a UE by exchanging information about the actions planned by the RAN upon receiving RVQoE reports from the UEs, e.g., the one or more wireless devices 131, 132. The tighter coordination may ensure higher efficiency of interventions taken by the RAN based on RVQoE measurement results and avoidance of unintended consequences due to lack of coordination. In other words, the UE applications, e.g., the applications of the wireless device 131, may make use of the allocated resources for purposes intended by the RAN.

Embodiments herein may also describe how a decreased allocation to certain UE applications may have to be communicated. This may be required to balance out the instantaneous load on the network and may make sure that actions to improve QoE of a certain session do not affect the QoE of other unrelated sessions.

By having the possibility to suggest a supervised bitrate selection, the RAN may manage a larger set of high-bandwidth applications in parallel with better overall QoE/RVQoE, compared to a case where each UE application may be individually responsible for their bitrate selection. The above may be understood to circumvent the case where certain UE applications may chose very high encoding rates, and a few UE applications may have to choose lower encodings due to lack of resources.

Embodiments herein may be generally applicable to any service type subject to RVQoE measurements.

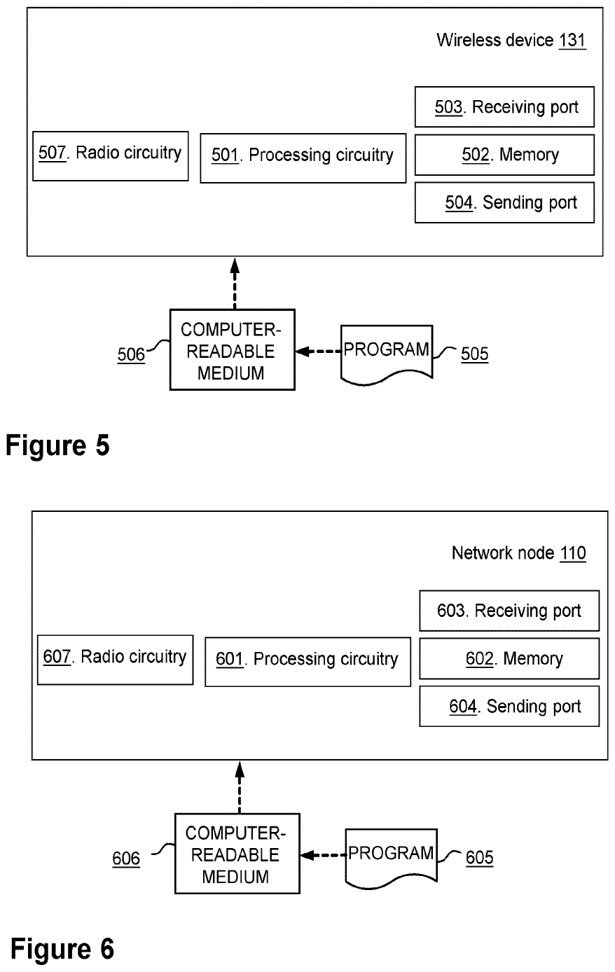

FIG. 5 depicts an example of the arrangement that the wireless device 131 may comprise to perform the method actions described above in relation to FIG. 2. The wireless device 131 may be understood to be for handling the one or more application layer measurements. The wireless device 131 is configured to operate in the wireless communications network 100.

In some embodiments, the wireless communications network 100 may be configured to support NR.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 131 and will thus not be repeated here. For example, the respective first indication may be configured to be RAN assistance information.

The wireless device 131 is configured and/or operable to perform the receiving in Action 204, e.g. by means of a processing circuitry 501 within the wireless device 131 configured to, receive, the respective first indication from the network node 110 configured to operate in the wireless communications network 100. The first indication is configured to indicate: a) the respective first configuration of the respective second indication of the one or more application layer measurements, and b) that the respective first configuration is based on one or more respective measurements, by the wireless device 131 or the other wireless devices 132. The one or more respective measurements comprise at least one of: application layer measurements and radio layer measurements.

The wireless device 131 is configured and/or operable to perform the sending in Action 206, e.g. by means of the processing circuitry 501 within the wireless device 131 configured to, send the respective application layer measurement report based on the respective first configuration configured to be indicated.

In some embodiments, at least one of the following may apply: a) the respective first configuration may be configured to be a RVQoE parameter configuration, and b) the respective second indication may be configured to be one of: i) the one or more parameters to perform the one or more application layer measurements, and ii) the report on the one or more application layer measurements.

In some embodiments, at least one of the following may apply: a) the respective first indication may be configured to be received in the first RRC message, b) the respective first indication may be configured to be comprised in the first MAC CE and/or the RRC message, c) the respective first indication may be configured to be assistance information, d) the first MAC CE may be configured to indicate one of: i) the scaling factor to be applied to the recommended bit rate, ii) the upper bound for the bit rate, iii) the lower bound for the bit rate, and iv) the start or the stop of the validity of the respective first configuration, e) the respective first indication may be configured to be comprised in the first field in the first MAC CE, f) the first MAC CE may be configured to be the Recommended bit rate MAC CE, g) the first field may be configured to be the field “X”, h) the respective first indication may be configured to be comprised as the first flag in the first MAC CE, i) the receiving may be configured to be from a CU managed by the network node 110, j) the respective first configuration may be configured to be an IE indicating the RAN assistance supervised maximum encoding bit rate, and k) the sending of the respective application layer measurement report may be configured to be to the network node 110.

In some embodiments, the respective first indication may be configured to indicate one of the following: a) that the respective first configuration has been activated or inactivated, b) that the respective first configuration has been activated or inactivated for a session, c) the maximum encoding rate to be used by the wireless device 131 for the application traffic, d) the guaranteed bit rate to be provided to the wireless device 131, e) whether the guaranteed bit rate is a minimum guaranteed bit rate, an average bit rate or a maximum bit rate, f) the condition the respective first configuration may be subject to, g) that the respective first configuration is to be provided at a future timepoint, upon fulfilment of the condition, h) the condition the respective first configuration may be subject to, wherein the condition may be other prioritized traffic at the network node 110, i) that the resource allocated to the wireless device 131 may be temporarily, reduced, j) that the resource allocated to the wireless device 131 may be temporarily, increased, k) the time period during which the respective first configuration may be to remain active, I) the one or more conditions for the respective first configuration to remain active, and m) the cancellation of the previously provided respective first configuration.

In some embodiments, applying of the received first configuration to the respective application layer measurement report may be configured to be subject to the fulfilment of the condition.

In some embodiments, the respective first indication may be configured to indicate that the resource allocated to the wireless device 131 is temporarily reduced, and the respective first indication may be configured to comprise at least one IE indicating at least one of: a) QoS reduction is underway and b) the one or more parameters the application is to abide by. The one or more parameters may be configured to be selected from: i) RANInitiatedQoSReduction, ii) RANInitiatedQoSReductionDuration, and iii) RANInitiatedQoSReductionMaxEncoding rate.

In some embodiments, the wireless device 131 may be configured with at least one of the following three configurations.

The wireless device 131 may be configured and/or operable to, before receiving the respective first indication, perform the sending in Action 201, e.g. by means of the processing circuitry 501 within the wireless device 131 configured to, send the respective first previous indication to the network node 110. The respective first previous indication may be configured to indicate the one or more capabilities of the wireless device 131. The received respective first indication may be configured to be based on the sent respective first previous indication.

The wireless device 131 may be configured and/or operable to, before receiving the respective first indication, perform the sending in this Action 202, e.g. by means of the processing circuitry 501 within the wireless device 131 configured to, send the respective second previous indication to the network node 110. The respective second previous indication may be configured to indicate the application used by the wireless device 131. The received respective first indication may be configured to be based on the indicated respective application.

The wireless device 131 may be configured and/or operable to, before receiving the respective first indication, perform the sending in this Action 203, e.g. by means of the processing circuitry 501 within the wireless device 131 configured to, send, to the network node 110, the one or more respective third previous indications configured to indicate the one or more respective measurements performed by the wireless device 131. The one or more respective measurements may comprise at least one of: application layer measurements and radio layer measurements. The received respective first indication may be based on the respective third previous indication configured to be sent.

In some embodiments, the respective third previous indication may be configured to be a RVQoE report.

The wireless device 131 may be configured and/or operable to perform the receiving in this Action 205, e.g. by means of the processing circuitry 501 within the wireless device 131 configured to, receive the respective third indication from the network node 110 based on the received respective first indication. The respective third indication may be configured to indicate the respective second configuration of radio resources. The received respective second configuration may be configured to be applied to the respective application layer measurement report configured to be sent.

In some embodiments, at least one of the following may apply: a) the respective third indication may be configured to be received in the second RRC message, b) the respective third indication may be configured to be comprised in the second MAC CE message, and c) the second MAC CE may be configured to indicate the start or the stop of the validity of the respective first indication.

The embodiments herein in the wireless device 131 may be implemented through one or more processors, such as a processing circuitry 501 in the wireless device 131 depicted in FIG. 5a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 131. One such carrier may be in the form of a CD ROM disc. It is however feasible with other data carriers such as a memory stick. The computer program code may furthermore be provided as pure program code on a server and downloaded to the wireless device 131.

The processing circuitry 501 may be configured to, or operable to, perform the method actions according to FIG. 2.

The wireless device 131 may further comprise a memory 502 comprising one or more memory units. The memory 502 is arranged to be used to store obtained information, store data, configurations, schedulings, and applications etc. to perform the methods herein when being executed in the wireless device 131.

In some embodiments, the wireless device 131 may receive information from, e.g., the network node 110, the other wireless devices 132, or another structure in the wireless communications network 100, through a receiving port 503. In some embodiments, the receiving port 503 may be, for example, connected to one or more antennas in wireless device 131. In other embodiments, the wireless device 131 may receive information from another structure in the wireless communications network 100 through the receiving port 503. Since the receiving port 503 may be in communication with the processing circuitry 501, the receiving port 503 may then send the received information to the processing circuitry 501. The receiving port 503 may also be configured to receive other information.

The processing circuitry 501 in the wireless device 131 may be further configured to transmit or send information to e.g., the network node 110, the other wireless devices 132, or another structure in the wireless communications network 100, through a sending port 504, which may be in communication with the processing circuitry 501, and the memory 502.

Those skilled in the art will also appreciate that the processing circuitry 501 described above may comprise a combination of analog and digital modules, and/or one or more processors configured with software and/or firmware, e.g., stored in memory, that, when executed by the one or more processors such as the processing circuitry 501, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the wireless device 131 may be configured to perform the actions of FIG. 2 with respective units that may be implemented as one or more applications running on one or more processors such as the processing circuitry 501.

Thus, the methods according to the embodiments described herein for the wireless device 131 may be respectively implemented by means of a computer program 505 product, comprising instructions, i.e., software code portions, which, when executed on at least one processing circuitry 501, cause the at least one processing circuitry 501 to carry out the actions described herein, as performed by the wireless device 131. The computer program 505 product may be stored on a computer-readable storage medium 506. The computer-readable storage medium 506, having stored thereon the computer program 505, may comprise instructions which, when executed on at least one processing circuitry 501, cause the at least one processing circuitry 501 to carry out the actions described herein, as performed by the wireless device 131. In some embodiments, the computer-readable storage medium 506 may be a non-transitory computer-readable storage medium, such as a CD ROM disc, or a memory stick. In other embodiments, the computer program 505 product may be stored on a carrier containing the computer program 505 just described, wherein the carrier is one of an electronic signal, optical signal, radio signal, or the computer-readable storage medium 506, as described above.

The wireless device 131 may comprise a communication interface configured to facilitate communications between the wireless device 131 and other nodes or devices, e.g., the network node 110, the other wireless devices 132, or another structure in the wireless communications network 100. The interface may, for example, include a transceiver configured to transmit and receive radio signals over an air interface in accordance with a suitable standard.

In other embodiments, the wireless device 131 may also comprise a radio circuitry 507, which may comprise e.g., the receiving port 503 and the sending port 504. The radio circuitry 507 may be configured to set up and maintain at least a wireless connection with the network node 110, the other wireless devices 132, or another structure in the wireless communications network 100. Circuitry may be understood herein as a hardware component.

Hence, embodiments herein also relate to the wireless device 131 comprising the processing circuitry 501 and the memory 502, said memory 502 containing instructions executable by said processing circuitry 501, whereby the wireless device 131 may be operative to perform the actions described herein in relation to the wireless device 131, e.g., in FIG. 2.

FIG. 6 depicts an example of the arrangement that the network node 110 may comprise to perform the method actions described above in relation to FIG. 3. The network node 110 may be understood to be for handling the one or more application layer measurements. The network node 110 may be configured to operate in the wireless communications network 100.

In some embodiments, the wireless communications network 100 may be configured to support NR.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the network node 110 and will thus not be repeated here. For example, the respective first indication may be configured to be RAN assistance information.

The network node 110 is configured and/or operable to perform the sending in Action 305, e.g. by means of a processing circuitry 601 within the network node 110 configured to, send the one or more respective first indications to at least one wireless device 131 of the one or more wireless devices 131, 132. Each of the one or more respective first indications is configured to indicate: a) the respective first configuration of the respective second indication of the one or more respective application layer measurements, and b) that the respective first configuration is based on the one or more respective measurements, by the wireless device 131 or other wireless devices 132. The one or more respective measurements are configured to comprise at least one of: application layer measurements and radio layer measurements.

The network node 110 is configured and/or operable to perform the receiving in Action 307, e.g. by means of the processing circuitry 601 within the network node 110 configured to, receive the respective application layer measurement report from the wireless device 131 based on the respective first configuration configured to be indicated.

In some embodiments, at least one of the following may apply: a) the respective first configuration may be configured to be a RVQoE parameter configuration, and b) the respective second indication may be configured to be one of: i) the one or more parameters to perform the one or more respective application layer measurements, and ii) the report on the one or more application layer measurements.

In some embodiments, at least one of the following may apply: a) the respective first indication may be configured to be received in the first RRC message, b) the respective first indication may be configured to be comprised in the first MAC CE and/or the RRC message, c) the respective first indication may be configured to be assistance information, d) the first MAC CE may be configured to indicate one of: i) the scaling factor to be applied to the recommended bit rate, ii) the upper bound for the bit rate, iii) the lower bound for the bit rate, and iv) the start or the stop of the validity of the respective first configuration, e) the respective first indication may be configured to be comprised in the first field in the first MAC CE, f) the first MAC CE may be configured to be the Recommended bit rate MAC CE, g) the first field may be configured to be the field “X”, h) the respective first indication may be configured to be comprised as the first flag in the first MAC CE, i) the sending of the one or more respective first indications may be configured to be by the CU managed by the network node 110, and j) the respective first configuration may be configured to be an IE indicating the RAN assistance supervised maximum encoding bit rate.

In some embodiments, the respective first indication may be configured to indicate one of the following: a) that the respective first configuration has been activated or inactivated, b) that the respective first configuration has been activated or inactivated for a session, c) the maximum encoding rate to be used by the wireless device 131 for the application traffic, d) the guaranteed bit rate to be provided to the wireless device 131, e) whether the guaranteed bit rate is a minimum guaranteed bit rate, an average bit rate or a maximum bit rate, f) the condition the respective first configuration may be subject to, g) that the respective first configuration is to be provided at a future timepoint, upon fulfilment of the condition, h) the condition the respective first configuration may be subject to, wherein the condition may be other prioritized traffic at the network node 110, i) that the resource allocated to the wireless device 131 may be temporarily, reduced, j) that the resource allocated to the wireless device 131 may be temporarily, increased, k) the time period during which the respective first configuration may be to remain active, I) the one or more conditions for the respective first configuration to remain active, and m) the cancellation of the previously provided respective first configuration.

In some embodiments, the application of the sent respective first configuration to the application layer measurement report may be configured to be subject to the fulfilment of the condition.

In some embodiments, the respective first indication may be configured to indicate that the resource allocated to the wireless device 131 is temporarily reduced, and the respective first indication may be configured to comprise at least one IE configured to indicate at least one of: a) QoS reduction is underway and b) the one or more parameters the application is to abide by. The one or more parameters may be configured to be selected from: i) RANInitiatedQoSReduction, ii) RANInitiatedQoSReductionDuration, and iii) RANInitiatedQoSReductionMaxEncoding rate.

In some embodiments, the network node 110 may be further configured with at least one of the following three configurations.

The network node 110 may be further configured and/or operable to, before sending the respective first indication, perform the receiving in Action 301, e.g. by means of the processing circuitry 601 within the network node 110 configured to, receive the respective first previous indication from the one or more wireless devices 131,132. The first previous indication may be configured to indicate the one or more respective capabilities of the respective one or more wireless devices 131,132. The respective first indications configured to be sent may be configured to be based on the received respective previous indications.

The network node 110 may be further configured and/or operable to, before sending the respective first indication, perform the receiving in Action 302, e.g. by means of the processing circuitry 601 within the network node 110 configured to, receive the respective second previous indication from the one or more wireless devices 131,132. The second previous indication may be configured to indicate the respective application used by the respective one or more wireless devices 131,132. The respective first indications configured to be sent may be configured to be based on the respective application configured to be indicated.

The network node 110 may be further configured and/or operable to, before sending the respective first indication, perform the receiving in Action 303, e.g. by means of the processing circuitry 601 within the network node 110 configured to, receive, from the one or more wireless devices 131,132, the one or more respective third previous indications configured to indicate the one or more respective measurements configured to be respectively performed by the one or more wireless devices 131,132. The one or more respective measurements may be configured to comprise at least one of: application layer measurements and radio layer measurements. The respective first indication configured to be sent may be configured to be based on the respective third previous indication configured to be received.

In some embodiments, the respective third previous indication may be configured to be a RVQoE report.

The network node 110 may be configured and/or operable to perform the sending in Action 306, e.g. by means of the processing circuitry 601 within the network node 110 configured to, send the respective third indication to the one or more wireless devices 131,132 based on the respective first indications configured to be sent. The respective third indications may be configured to indicate the respective second configuration of radio resources. The respective application layer measurement report configured to be received may be configured to be based on the respective second configuration configured to be sent.

In some embodiments, at least one of the following may apply: a) the respective third indication may be configured to be sent in the second RRC message, b) the respective third indication may be configured to be comprised in the second MAC CE message, and c) the second MAC CE may be configured to indicate the start or the stop of the validity of the respective first indication.

The network node 110 may be configured and/or operable to perform the determining in Action 304, e.g. by means of the processing circuitry 601 within the network node 110 configured to, determine, based on at least one of the respective first previous indication, respective second previous indication and one or more respective third previous indications configured to be received, whether or not to send the respective first indications to the one or more wireless devices 131,132 and/or the respective content of the respective first configurations. The sent respective first indications may be based on the result of the determination.

The embodiments herein in the network node 110 may be implemented through one or more processors, such as a processing circuitry 601 in the network node 110 depicted in FIG. 6a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The processing circuitry 601 may be configured to, or operable to, perform the method actions according to FIG. 3.

The network node 110 may further comprise a memory 602 comprising one or more memory units. The memory 602 is arranged to be used to store obtained information, store data, configurations, schedulings, and applications etc. to perform the methods herein when being executed in the network node 110.

In some embodiments, the network node 110 may receive information from, e.g., the one or more wireless devices 131, 132, that is, the wireless device 131, the other wireless devices 132, and/or another structure in the wireless communications network 100, through a receiving port 603. In some embodiments, the receiving port 603 may be, for example, connected to one or more antennas in network node 110. In other embodiments, the network node 110 may receive information from another structure in the wireless communications network 100 through the receiving port 603. Since the receiving port 603 may be in communication with the processing circuitry 601, the receiving port 603 may then send the received information to the processing circuitry 601. The receiving port 603 may also be configured to receive other information.

The processing circuitry 601 in the network node 110 may be further configured to transmit or send information to e.g., the one or more wireless devices 131, 132, that is, the wireless device 131, the other wireless devices 132, and/or another structure in the wireless communications network 100, through a sending port 604, which may be in communication with the processing circuitry 601, and the memory 602.

Those skilled in the art will also appreciate that the processing circuitry 601 described above may comprise a combination of analog and digital modules, and/or one or more processors configured with software and/or firmware, e.g., stored in memory, that, when executed by the one or more processors such as the processing circuitry 601, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the network node 110 may be configured to perform the actions of FIG. 3 with respective units that may be implemented as one or more applications running on one or more processors such as the processing circuitry 601.

Thus, the methods according to the embodiments described herein for the network node 110 may be respectively implemented by means of a computer program 605 product, comprising instructions, i.e., software code portions, which, when executed on at least one processing circuitry 601, cause the at least one processing circuitry 601 to carry out the actions described herein, as performed by the network node 110. The computer program 605 product may be stored on a computer-readable storage medium 606. The computer-readable storage medium 606, having stored thereon the computer program 605, may comprise instructions which, when executed on at least one processing circuitry 601, cause the at least one processing circuitry 601 to carry out the actions described herein, as performed by the network node 110. In some embodiments, the computer-readable storage medium 606 may be a non-transitory computer-readable storage medium, such as a CD ROM disc, or a memory stick. In other embodiments, the computer program 605 product may be stored on a carrier containing the computer program 605 just described, wherein the carrier is one of an electronic signal, optical signal, radio signal, or the computer-readable storage medium 606, as described above.

The network node 110 may comprise a communication interface configured to facilitate communications between the network node 110 and other nodes or devices, e.g., the one or more wireless devices 131, 132, that is, the wireless device 131, the other wireless devices 132, and/or another structure in the wireless communications network 100. The interface may, for example, include a transceiver configured to transmit and receive radio signals over an air interface in accordance with a suitable standard.

In other embodiments, the network node 110 may also comprise a radio circuitry 607, which may comprise e.g., the receiving port 603 and the sending port 604. The radio circuitry 607 may be configured to set up and maintain at least a wireless connection with the one or more wireless devices 131, 132, that is, the wireless device 131, the other wireless devices 132, and/or another structure in the wireless communications network 100. Circuitry may be understood herein as a hardware component.

Hence, embodiments herein also relate to the network node 110 comprising the processing circuitry 601 and the memory 602, said memory 602 containing instructions executable by said processing circuitry 601, whereby the network node 110 may be operative to perform the actions described herein in relation to the network node 110, e.g., in FIG. 3.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

### Examples Related to Embodiments Herein

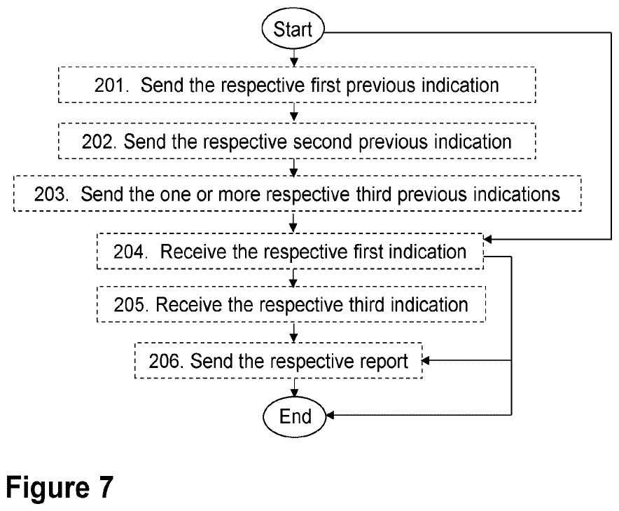

FIG. 7 depicts a method performed by the wireless device 131 in examples related to embodiments herein, according to the description of the actions provided in relation to FIG. 2.

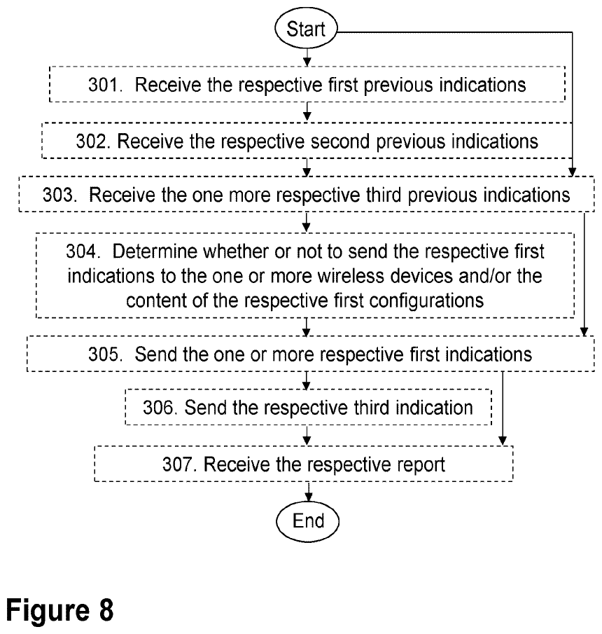

FIG. 8 depicts a method performed by the network node 110 in examples related to embodiments herein, according to the description of the actions provided in relation to FIG. 3.

The wireless device 131 embodiments relate to FIG. 7, FIG. 4, FIG. 5 and FIGS. 9-11.

A method, performed by a wireless device, such as the wireless device 131 is described herein. The method may be understood to be for handling one or more application layer measurements. The wireless device 131 may be operating in a wireless communications network, such as the wireless communications network 100.

In some embodiments, the wireless communications network 100 may support New Radio (NR).

The method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 131 is depicted in FIG. 7. In FIG. 7 optional actions in some embodiments may be represented with dashed lines. In some embodiments, the actions may be performed in a different order than that depicted FIG. 7.
Receiving 204 a first indication, e.g., a respective first indication. The wireless device 131 may be configured and/or operable to perform the receiving in this Action 204.

The receiving in this Action 204 may be from the network node 110 operating in the wireless communications network 100.

The receiving in this Action 204 may be performed, e.g., via the first link 141, e.g., in a dedicated or as part of a group message, e.g., received via system information.

The first indication may indicate, e.g., at least one of:
a) a respective first configuration; the respective first configuration may be of a respective second indication; the respective second indication may be of the one or more application layer measurements, and
b) that the respective first configuration is based on one or more respective measurements; the one or more respective measurements may be by the wireless device 131 or the other wireless devices 132; the one or more respective measurements may comprise at least one of: application layer measurements and radio layer measurements.

In some examples, at least one of the following may apply:
the respective first configuration may be a Radio Access Network Visible Quality of Experience (RVQoE) parameter configuration, and
the respective second indication may be one of:
   i. one or more parameters; the one or more parameters may be to perform the one or more application layer measurements, and
   ii. a report; the report may be on the one or more application layer measurements.

In some examples, at least one of the following may apply:
the respective first indication may be received in a first Radio Resource Control (RRC) message, e.g., in an RRCReconfiguration message,
the respective first indication may be comprised in a first Medium Access Control (MAC) Control Element (CE) and/or an RRC message,
the respective first indication may be assistance information, e.g., RAN assistance information,
the first MAC CE may indicate one of:
   i. a scaling factor to be applied to a recommended bit rate,
   ii. an upper bound for the bit rate,
   iii. a lower bound for the bit rate, and
   iv. a start or a stop of a validity of the first configuration,
the respective first indication may be comprised in a first field in the first MAC CE,
the first MAC may be is a Recommended bit rate MAC CE,
the first field may be a field “X”,
the respective first indication may be comprised as a first flag in the first MAC CE, e.g., “Scale”, which may be encoded as a single bit,
the receiving in Action 204 may be from a Central Unit managed by the network node 110, and
the respective first configuration may be an Information Element (IE) indicating a Radio Access Network (RAN) assistance supervised maximum encoding bit rate.

In some examples, the respective first indication may indicate one of the following:
that the respective first configuration has been activated or inactivated,
that the respective first configuration has been activated or inactivated for a session,
a maximum encoding rate to be used by the wireless device 131 for the application traffic,
a guaranteed bit rate to be provided to the wireless device 131,
whether the guaranteed bit rate is a minimum guaranteed bit rate, an average bit rate or a maximum bit rate,
a condition the first configuration may be subject to,
that the respective first configuration is to be provided at a future timepoint, upon fulfillment of the condition,
the condition the respective first configuration may be subject to, wherein the condition is other prioritized traffic at the network node 110,
that a resource allocated to the wireless device 131 is e.g., temporarily, reduced,
that the resource allocated to the wireless device 131 is e.g., temporarily, increased,
a time period during which the respective first configuration is to remain active for example, until an RRC reconfiguration message is received without any RAN assistance parameter(s). Examples of other conditions will be provided later on;
one or more conditions for the respective first configuration to remain active, and
a cancellation of a previously provided respective first configuration.

The one or more conditions may comprise for example, one or more reported RVQoE metrics or RVQoE value, e.g., in relation to a threshold.

In some examples, the applying of the received first configuration to the respective application layer measurement report may be subject to the fulfilment of the condition.

In some examples, the respective first indication may indicate that the resource allocated to the wireless device 131 may be e.g., temporarily reduced; in some of these examples, the respective first indication may comprise at least one IE indicating at least one of:
QoS reduction is underway and
   i. one or more parameters the application may have to abide by; in some of these examples, the one or more parameters may be selected from:
   ii. RANInitiatedQoSReduction,
   iii. RANInitiatedQoSReductionDuration, and
   iv. RANInitiatedQoSReductionMaxEncoding rate.

See Table 2 and related description for further details and examples.
Sending 206 a respective application layer measurement report. The wireless device 131 may be configured and/or operable to perform the sending in this Action 206.

The sending in this Action 206 may be, e.g., to the network node 110.

The sending in this Action 206 may be, e.g., transmitting, and may be performed, e.g., via the first link 141.

The sending in this Action 206 of the respective application layer measurement report may be based on the indicated respective first configuration.

In some examples, at least one of the following may apply:
the respective first indication may be received in the first RRC message,
the respective first indication may be comprised in the first MAC CE in the RRC message,
the respective first indication may be assistance information,
the first MAC CE may indicate one of:
   i. the scaling factor to be applied to the recommended bit rate,
   ii. the upper bound for the bit rate,
   iii, the lower bound for the bit rate, and
   iv. the start or a stop of the validity of the first configuration,
the respective first indication may be comprised in the first field in the first MAC CE,
the first MAC may be is the Recommended bit rate MAC CE,
the first field may be the field “X”,
the respective first indication may be comprised as the first flag in the first MAC CE,
the receiving in Action 204 may be from the Central Unit managed by the network node 110,
the respective first configuration may be the IE indicating the RAN assistance supervised maximum encoding bit rate, and
the sending in Action 206 of the respective application layer measurement report may be to the network node 110.

In some embodiments, the method may further comprise one or more of the following three actions, e.g., before receiving the respective first indication:
Sending 201 a respective first previous indication. The wireless device 131 may be configured and/or operable to perform the sending in this Action 201.

The sending of the respective first previous indication in this Action 201 may be to the network node 110.

The sending in this Action 201 may be performed, e.g., via the first link 141.

The respective first previous indication may indicate one or more capabilities of the wireless device 131. The received respective first indication may be based on the sent respective first previous indication.

The one or more capabilities may be for the wireless device 131 to signal to the network node 110 that it may support receiving the respective first indication, e.g., RAN assistance information, and to indicate the range of potential UE actions that may be possible, that is, supported by the wireless device 131.
Sending 202 a respective second previous indication. The wireless device 131 may be configured and/or operable to perform the sending in this Action 202.

The sending in this Action 202 may be to the network node 110.

The sending in this Action 202 may be performed, e.g., via the first link 141.

The respective second previous indication may indicate an application used by the wireless device 131, e.g., by sending an application identifier. The received respective first indication may be based on the indicated application.
Sending 203 one or more respective third previous indications. The wireless device 131 may be configured and/or operable to perform the sending in this Action 203.

The sending in this Action 203 may be to the network node 110.

The sending in this Action 203 may be performed, e.g., via the first link 141.

The one or more respective third previous indications may indicate the one or more respective measurements performed by the wireless device 131. The one or more respective measurements may comprise at least one of: application layer measurements and radio layer measurements. The received respective first indication may be based on the sent respective third previous indication.

In some examples, the respective third previous indication may be a Radio Access Network Visible Quality of Experience (RVQoE) report.

In some embodiments, the method may further comprise one or more of the following actions:
Receiving 205 a respective third indication. The wireless device 131 may be configured and/or operable to perform the receiving in this Action 205.

The receiving in this Action 205 may be from the network node 110.

The receiving in this Action 205 may be performed, e.g., via the first link 141.

In some examples, the receiving in this Action 205 of the respective third indication from the network node 110 may be based on the received respective first indication.

The respective third indication may indicate a respective second configuration of radio resources.

The received respective second configuration may be applied to the sent respective application layer measurement report.

In some examples, at least one of the following may apply:
the respective third indication may be received in a second RRC message,
the respective third indication may be comprised in a second MAC CE message, and
the second MAC CE may indicate a start or a stop of the validity of the respective first indication.

In FIG. 7, optional units are indicated with dashed boxes.

The wireless device 131 may comprise an arrangement as shown in FIG. 5 or in

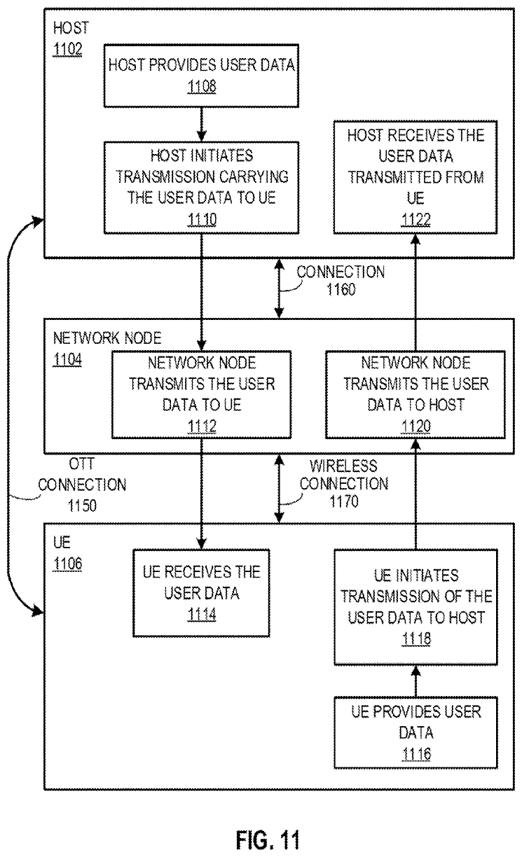

FIG. 11.

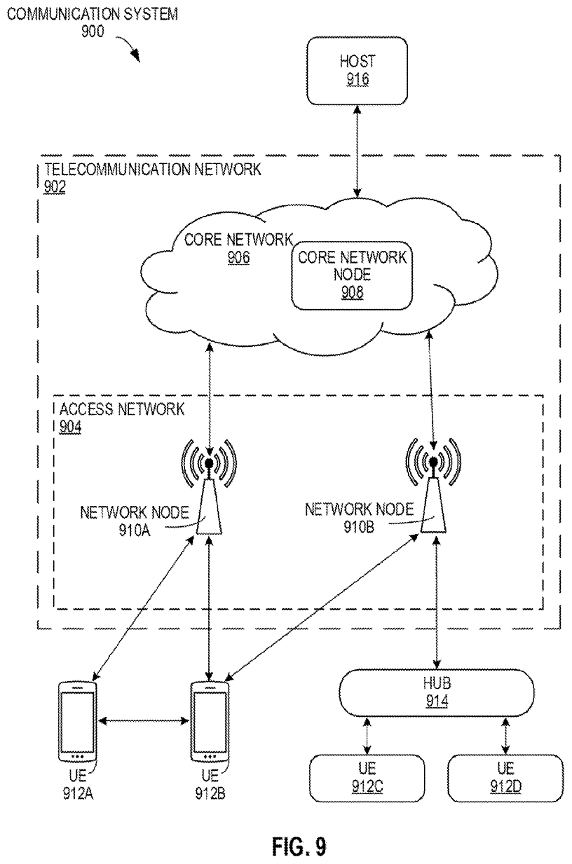

The network node 110 embodiments relate to FIG. 8, FIG. 4, FIG. 6, and FIGS. 9-11.

A method, performed by a network node, such as the network node 110 is described herein. The method may be understood to be for handling one or more application layer measurements. The network node 110 may be operating in a wireless communications network, such as the wireless communications network 100.

In some embodiments, the wireless communications network 100 may support New Radio (NR).

The first method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the network node 110 is depicted in FIG. 8. In FIG. 8, optional actions in some embodiments may be represented with dashed lines. In some embodiments, the actions may be performed in a different order than that depicted FIG. 8.

The detailed description of some of the following corresponds to the same references provided above, in relation to the actions described for the wireless device 131 and will thus not be repeated here to simplify the description. For example, the respective first indication may be RAN assistance information.
Receiving 303 one or more respective third previous indications. The network node 110 may be configured and/or operable to perform the receiving in this Action 303.

The receiving in this Action 303 may be from the one or more wireless devices 131, 132 operating in the wireless communications network 100, e.g., from the wireless device 131.

The receiving in this Action 301 may be performed, e.g., via the first link 141 and/or the respective other links.

The one or more respective third previous indications may indicate one or more respective measurements respectively performed by the one or more wireless devices 131, 132.

The one or more respective measurements may comprise at least one of: application layer measurements and radio layer measurements.
Sending 305 the one or more respective first indications. The network node 110 may be configured and/or operable to perform the sending in this Action 305.

The sending in this Action 305 may be to at least one wireless device 131 of the one or more wireless devices 131, 132.

In some examples, the network node 110 may send the one or more respective first indications to the one or more wireless devices 131, 132 at the same time, for example, as a group, e.g., via a System Information message, or a dedicated message.

The sending in this Action 302 may be performed, e.g., via the first link 141 and/or the respective other links.

Each of the one or more respective first indications may indicate at least one of:
a) a respective first configuration of a respective second indication of the one or more respective application layer measurements, and
b) that the respective first configuration is based on the one or more respective measurements, by the wireless device 131 or other wireless devices 132; the one or more respective measurements may comprise at least one of: application layer measurements and radio layer measurements received in the one or more respective third indications.
   Receiving 307 a respective application layer measurement report. The network node 110 may be configured and/or operable to perform the receiving in this Action 307.

The receiving in this Action 307 may be from the wireless device 131 based on the indicated respective first configuration.

In some examples, the receiving in this Action 307 may comprise receiving respective application layer measurement reports from several of the one or more wireless devices 131, 132.

The receiving in this Action 307 may be performed, e.g., via the first link 141 and/or the respective other links.

In some examples, at least one of the following may apply:
the respective first configuration may be a RVQoE, parameter configuration, and
the respective second indication may be one of:
   i. one or more parameters to perform the one or more respective application layer measurements, and
   ii. a report on the one or more application layer measurements.

In some examples, at least one of the following may apply:
the respective first indication may be received in an RRC message,
the respective first indication may be comprised in a first MAC CE in an RRC message,
the respective first indication may be assistance information,
the first MAC CE may indicate one of:
   i. a scaling factor to be applied to a recommended bit rate,
   ii. an upper bound for the bit rate,
   iii. a lower bound for the bit rate,
   iv. a start or a stop of a validity of the first configuration,
the respective first indication i may be s comprised in a first field in the first MAC CE,
the first MAC CE may be a Recommended bit rate MAC CE,
the first field may be a field “X”,
the respective first indication may be comprised as a first flag in the first MAC CE,
the sending in Action 305 may be by a Central Unit managed by the network node 110, and
the respective first configuration may be an IE indicating a RAN assistance supervised maximum encoding bit rate.

In some examples, the respective first indication may indicate one of the following:
that the respective first configuration has been activated or inactivated,
that the respective first configuration has been activated or inactivated for a session,
a maximum encoding rate to be used by the wireless device 131 for the application traffic,
a guaranteed bit rate to be provided to the wireless device 131,
whether the guaranteed bit rate is a minimum guaranteed bit rate, an average bit rate or a maximum bit rate,
a condition the first configuration is subject to,
that the respective first configuration is to be provided at a future timepoint, upon fulfillment of the condition,
the condition the respective first configuration may be subject to, wherein the condition may be other prioritized traffic at the network node 110,
that a resource allocated to the wireless device 131 is e.g., temporarily reduced,
that the resource allocated to the wireless device 131 is e.g., temporarily, increased,
a time period during which the respective first configuration is to remain active,
one or more conditions for the respective first configuration to remain active, and
a cancellation of a previously provided respective first configuration.

In some embodiments, the application of the sent respective first configuration to the application layer measurement report may be subject to the fulfilment of the condition.

In some examples, the respective first indication may indicate that the resource allocated to the wireless device 131 may be e.g., temporarily reduced. In some of these examples, the respective first indication may comprise at least one IE indicating at least one of:
QoS reduction is underway and
one or more parameters the application may have to abide by; the one or more parameters may be selected from:
   i. RANInitiatedQoSReduction,
   ii. RANInitiatedQoSReductionDuration, and
   iii. RANInitiatedQoSReductionMaxEncoding rate.

In some embodiments, the method may further comprise one or more of the following three actions, e.g., before sending the respective first indication:
Receiving 301 a respective first previous indication. The network node 110 may be configured and/or operable to perform the receiving in this Action 301.

The receiving in this Action 301 may be from the one or more wireless devices 131, 132.

The receiving in this Action 301 may be performed, e.g., via the first link 141 and/or the respective other links.

The first previous indication may indicate one or more respective capabilities of the respective one or more wireless devices 131,132. The sent respective first indications may be based on the received respective previous indications.
Receiving 302 a respective second previous indication. The network node 110 may be configured and/or operable to perform the receiving in this Action 302.

The receiving in this Action 302 may be from the one or more wireless devices 131, 132.

The receiving in this Action 302 may be performed, e.g., via the first link 141 and/or the respective other links.

The second previous indication may indicate a respective application used by the respective one or more wireless devices 131,132. The sent respective first indication may be based on the indicated respective application.
Receiving 303 one or more respective third previous indications. The network node 110 may be configured and/or operable to perform the receiving in this Action 303.

The receiving in this Action 303 may be from the one or more wireless devices 131, 132.

The receiving in this Action 303 may be performed, e.g., via the first link 141 and/or the respective other links.

The one or more respective third previous indications may indicate the one or more respective measurements performed by the one or more wireless devices 131,132. The one or more respective measurements may comprise at least one of: application layer measurements and radio layer measurements. The sent respective first indication may be based on the received respective third previous indication.

The respective third previous indication may be a RVQoE report.
Sending 306 a respective third indication. The network node 110 may be configured and/or operable to perform the sending in this Action 306.

The sending in this Action 306 may be to the one or more wireless devices 131, 132.

The sending in this Action 306 may be performed, e.g., via the first link 141 and/or the respective other links.

The sending in this Action 306 of the respective third indication may be based on the sent respective first indications. The respective third indications may indicate a respective second configuration of radio resources. The received respective application layer measurement report may be based on the sent respective second configuration.

In some examples, at least one of the following may apply:
the respective third indication may be sent in a second RRC message,
the respective third indication may be comprised in a second MAC CE message, and
the second MAC CE may indicate a start or a stop of the validity of the respective first indication.
   Determining 304 whether or not to send the respective first indications to the one or more wireless devices 131,132, e.g., and/or a respective content of the respective first configuration. The network node 110 may be configured and/or operable to perform the determining in this Action 304.

Determining may be understood as deciding, selecting, or similar.

The determining in this Action 304 may be based on at least one of the received respective first previous indication, respective second previous indication and one or more respective third previous indications.

The determining in this Action 304 may be alternatively or additionally based on a load of the RAN, e.g., of the network node 110, and/or characteristics of traffic on the RAN, e.g., on the network node 110.

The determining in this Action 304 may be alternatively or additionally based on other factors.

The sent respective first indications may be based on a result of the determination. In FIG. 6, optional units are indicated with dashed boxes.

The network node 110 may comprise an arrangement as shown in FIG. 6 or in FIG. 11.

### Further Extensions and Variations

FIG. 9 shows an example of a communication system 900 in accordance with some embodiments.

In the example, the communication system 900, such as the wireless communications network 100, includes a telecommunication network 902 that includes an access network 904, such as a radio access network (RAN), and a core network 906, which includes one or more core network nodes 908. The access network 904 includes one or more access network nodes, such as the network node 110. For example, network nodes 910a and 910b, one or more of which may be generally referred to as network nodes 910, or any other similar 3^{rd} Generation Partnership Project (3GPP) access node or non-3GPP access point. The communications system 900 comprises a plurality of wireless devices, such as the wireless device 131 and/or the other wireless devices 132. It may be understood that, in reference to any of FIGS. 9-11, any reference to the wireless device 131 may be understood to equally apply to any of the other wireless devices 132. In FIG. 9, the plurality of wireless devices comprises UEs 912a, 912b, 912c, and 912d, one or more of which may be generally referred to as UEs 912. The network nodes 910 facilitate direct or indirect connection of user equipment (UE), such as by connecting UEs 912a, 912b, 912c, and 912d to the core network 906 over one or more wireless connections. Any of the UEs 912a, 912b, 912c, and 912d are examples of the wireless device 131.

In relation to FIGS. 9, 10, and 11, which are described next, it may be understood that any UE is an example of the wireless device 131, and that any description provided for the UE 912 or for the UE 1106 equally applies to the wireless device 131. It may be also understood that any network node is an example of the network node 110, and that any description provided for any network node 910 or for the network node 1104 equally applies to the network node 110. It may further be understood that the communication system 900 is an example of the wireless communication network 100, and that any description provided for the communication system 900 equally applies to the wireless communication network 100.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The wireless device 131, exemplified in FIG. 9 as the UEs 912, may be any of a wide variety of communication devices, including wireless devices arranged, configured, and/or operable to communicate wirelessly with the network node 110, exemplified in FIG. 9 as network nodes 910, and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes, e.g., core network node 908, that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), MME, HSS, AMF, Session Management Function (SMF), Authentication Server Function (AUSF), Subscription Identifier De-concealing function (SIDF), UDM, Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902 and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); UMTS; Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs. In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, New Radio (NR) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs, e.g., UE 912c and/or 912d, and network nodes, e.g., network node 910b. In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

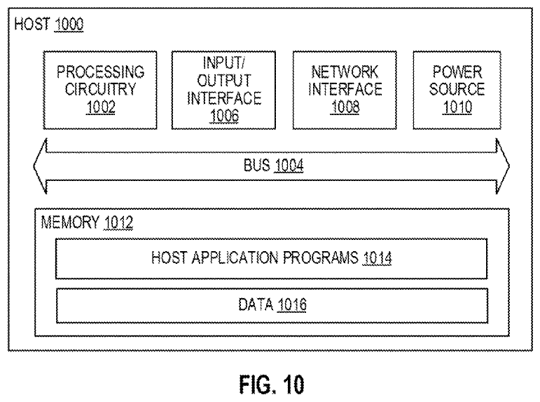

FIG. 10 is a block diagram of a host 1000, which may be an embodiment of the host 916 of FIG. 9, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs, (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 shows a communication diagram of a host 1102 communicating via a network node 1104 with a UE 1106 over a partially wireless connection in accordance with some embodiments. Example implementations, in accordance with various embodiments, of the UE, such as a UE 912a of Figure QQ, network node, such as network node 910a of FIG. 9, and host, such as host 916 of FIG. 9 and/or host 1000 of FIG. 10, discussed in the preceding paragraphs will now be described with reference to FIG. 11.

Like host 1000, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 906 of FIG. 9) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the data rate, latency, power consumption and thereby provide benefits such as reduced user waiting time, relaxed restriction on file size, improved content resolution, better responsiveness, and extended battery lifetime.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion, e.g., controlling traffic lights. As another example, the host 1102 may store surveillance video uploaded by a UE.

As another example, the host 1102 may store or control access to media content such as video, audio, VR or AR which it can broadcast, multicast or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1150 between the host 1102 and UE 1106, in response to variations in the measurement results. The measurement procedure and/or the network functionality for reconfiguring the OTT connection may be implemented in software and hardware of the host 1102 and/or UE 1106. In some embodiments, sensors, not shown, may be deployed in or in association with other devices through which the OTT connection 1150 passes; the sensors may participate in the measurement procedure by supplying values of the monitored quantities exemplified above, or supplying values of other physical quantities from which software may compute or estimate the monitored quantities. The reconfiguring of the OTT connection 1150 may include message format, retransmission settings, preferred routing etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency and the like, by the host 1102. The measurements may be implemented in that software causes messages to be transmitted, in particular empty or ‘dummy’ messages, using the OTT connection 1150 while monitoring propagation times, errors, etc.

The wireless device 131 embodiments relate to FIG. 2, FIG. 4, FIG. 5 and FIGS. 9-11.

The wireless device 131 may comprise an arrangement as shown in FIG. 5 or in FIG. 11.

The network node 110 embodiments relate to FIG. 3, FIG. 4, FIG. 6, and FIGS. 9-11.

The network node 110 may comprise an arrangement as shown in FIG. 6 or in FIG. 11.

### Further Numbered Embodiments

1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform one or more of the actions described herein as performed by the network node 110.
2. The host of the previous embodiment, wherein:
the processing circuitry of the host is configured to execute a host application that provides the user data; and
the UE comprises processing circuitry configured to execute a client application associated with the host application to receive the transmission of user data from the host.
3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs one or more of the actions described herein as performed by the network node 110.
4. The method of the previous embodiment, further comprising, at the network node, transmitting the user data provided by the host for the UE.
5. The method of any of the previous 2 embodiments, wherein the user data is provided at the host by executing a host application that interacts with a client application executing on the UE, the client application being associated with the host application.
6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform one or more of the actions described herein as performed by the network node 110.
7. The communication system of the previous embodiment, further comprising:
the network node; and/or
the user equipment.
8. The communication system of the previous 2 embodiments, wherein:
the processing circuitry of the host is configured to execute a host application, thereby providing the user data; and
the host application is configured to interact with a client application executing on the UE, the client application being associated with the host application.
9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform one or more of the actions described herein as performed by the network node 110.
10. The host of the previous 2 embodiments, wherein:
the processing circuitry of the host is configured to execute a host application, thereby providing the user data; and
the host application is configured to interact with a client application executing on the UE, the client application being associated with the host application.
11. The host of the any of the previous 2 embodiments, wherein the initiating receipt of the user data comprises requesting the user data.
12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs one or more of the actions described herein as performed by the network node 110.
13. The method of the previous embodiment, further comprising at the network node, transmitting the received user data to the host.
14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform one or more of the actions described herein as performed by the wireless device 131.
15. The host of the previous embodiment, wherein the cellular network further includes a network node configured to communicate with the UE to transmit the user data to the UE from the host.
16. The host of the previous 2 embodiments, wherein:
the processing circuitry of the host is configured to execute a host application, thereby providing the user data; and
the host application is configured to interact with a client application executing on the UE, the client application being associated with the host application.
17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs one or more of the actions described herein as performed by the wireless device 131.
18. The method of the previous embodiment, further comprising:
at the host, executing a host application associated with a client application executing on the UE to receive the user data from the UE.
19. The method of the previous embodiment, further comprising:
at the host, transmitting input data to the client application executing on the UE, the input data being provided by executing the host application,
wherein the user data is provided by the client application in response to the input data from the host application.
20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform one or more of the actions described herein as performed by the wireless device 131.
21. The host of the previous embodiment, wherein the cellular network further includes a network node configured to communicate with the UE to transmit the user data from the UE to the host.
22. The host of the previous 2 embodiments, wherein:
the processing circuitry of the host is configured to execute a host application, thereby providing the user data; and
the host application is configured to interact with a client application executing on the UE, the client application being associated with the host application.
23. A method implemented by a host configured to operate in a communication system that further includes a network node and a user equipment (UE), the method comprising:
at the host, receiving user data transmitted to the host via the network node by the UE, wherein the UE performs one or more of the actions described herein as performed by the wireless device 131.
24. The method of the previous embodiment, further comprising:
at the host, executing a host application associated with a client application executing on the UE to receive the user data from the UE.
25. The method of the previous embodiments, further comprising:
at the host, transmitting input data to the client application executing on the UE, the input data being provided by executing the host application,
wherein the user data is provided by the client application in response to the input data from the host application.

1-42. (canceled)

43. A method performed by a wireless device, the method being for handling one or more application layer measurements, the wireless device operating in a wireless communications network, and the method comprising:
receiving, a respective first indication from a network node operating in the wireless communications network, the first indication indicating:
a respective first configuration of a respective second indication of the one or more application layer measurements; and
that the respective first configuration is based on one or more respective measurements, by the wireless device or other wireless devices, the one or more respective measurements comprising at least one of: application layer measurements and radio layer measurements; and
sending a respective application layer measurement report based on the indicated respective first configuration.

44. The method of claim 43, wherein at least one of:
the respective first configuration is a Radio Access Network Visible Quality of Experience, RVQoE, parameter configuration; and
the respective second indication is one of:
one or more parameters to perform the one or more application layer measurements; and
a report on the one or more application layer measurements.

45. The method of claim 43, wherein at least one of:
the respective first indication is received in a first Radio Resource Control, RRC, message;
the respective first indication is comprised in a first Medium Access Control, MAC, Control Element, CE, and/or an RRC message;
the respective first indication is assistance information;
the first MAC CE indicates one of:
a scaling factor to be applied to a recommended bit rate;
an upper bound for the bit rate;
a lower bound for the bit rate; and
a start or a stop of a validity of the respective first configuration;
the respective first indication is comprised in a first field in the first MAC CE;
the first MAC CE is a Recommended bit rate MAC CE;
the first field is a field “X”;
the respective first indication is comprised as a first flag in the first MAC CE;
the receiving is from a Central Unit managed by the network node;
the respective first configuration is an Information Element, IE, indicating a Radio Access Network, RAN, assistance supervised maximum encoding bit rate; and
the sending of the respective application layer measurement report is to the network node.

46. The method of claim 43, wherein the respective first indication indicates one of:
that the respective first configuration has been activated or inactivated;
that the respective first configuration has been activated or inactivated for a session;
a maximum encoding rate to be used by the wireless device for application traffic;
a guaranteed bit rate to be provided to the wireless device;
whether the guaranteed bit rate is a minimum guaranteed bit rate, an average bit rate or a maximum bit rate;
a condition the respective first configuration is subject to;
that the respective first configuration is to be provided at a future timepoint, upon fulfillment of the condition;
the condition the respective first configuration is subject to, wherein the condition is other prioritized traffic at the network node;
that a resource allocated to the wireless device is temporarily reduced;
that the resource allocated to the wireless device is temporarily, increased;
a time period during which the respective first configuration is to remain active;
one or more conditions for the respective first configuration to remain active; and
a cancellation of a previously provided respective first configuration.

47. The method of claim 46, wherein the applying of the received first configuration to the respective application layer measurement report is subject to the fulfillment of the condition.

48. The method of claim 46, wherein the respective first indication indicates that the resource allocated to the wireless device is temporarily reduced, and wherein the respective first indication comprises at least one Information Element, IE, indicating at least one of:
QoS reduction is underway; and
one or more parameters the application is to abide by the one or more parameters being selected from:
RANInitiatedQoSReduction;
RANInitiatedQoSReductionDuration; and
RANInitiatedQoSReductionMaxEncoding rate.

49. The method of claim 43, further comprising, before receiving the respective first indication:
sending a respective first previous indication to the network node, the respective first previous indication indicating one or more capabilities of the wireless device, and wherein the received respective first indication is based on the sent respective first previous indication;
sending a respective second previous indication to the network node, the respective second previous indication indicating an application used by the wireless device, and wherein the received respective first indication is based on the indicated respective application; and
sending, to the network node, one or more respective third previous indications indicating the one or more respective measurements performed by the wireless device, the one or more respective measurements comprising at least one of:
application layer measurements; and
radio layer measurements;
wherein the received respective first indication is based on the sent respective third previous indication.

50. The method of claim 49, wherein the respective third previous indication is a Radio Access Network Visible Quality of Experience, RVQoE, report.

51. The method of claim 50, further comprising receiving a respective third indication from the network node based on the received respective first indication, wherein:
the respective third indication indicates a respective second configuration of radio resources; and
the received respective second configuration is applied to the sent respective application layer measurement report.

52. The method of claim 51, wherein at least one of:
the respective third indication is received in a second RRC message;
the respective third indication is comprised in a second MAC CE message; and
the second MAC CE indicates a start or a stop of a validity of the respective first indication.

53. A wireless device for handling one or more application layer measurements, the wireless device comprising:
processing circuitry and memory containing instructions executable by the processing circuitry whereby the wireless device is configured to:
receive, a respective first indication from a network node configured to operate in the wireless communications network, the first indication being configured to indicate:
a respective first configuration of a respective second indication of the one or more application layer measurements; and
that the respective first configuration is based on one or more respective measurements, by the wireless device or other wireless devices, the one or more respective measurements comprising at least one of: application layer measurements and radio layer measurements; and
send a respective application layer measurement report based on the respective first configuration configured to be indicated.

54. The wireless device of claim 53, wherein at least one of:
the respective first configuration is a Radio Access Network Visible Quality of Experience, RVQoE, parameter configuration; and
the respective second indication is one of:
one or more parameters to perform the one or more application layer measurements; and
a report on the one or more application layer measurements.

55. The wireless device of claim 53, wherein at least one of:
the respective first indication is received in a first Radio Resource Control, RRC, message;
the respective first indication is comprised in a first Medium Access Control, MAC, Control Element, CE, and/or an RRC message;
the respective first indication is assistance information;
the first MAC CE indicates one of:
a scaling factor to be applied to a recommended bit rate;
an upper bound for the bit rate;
a lower bound for the bit rate; and
a start or a stop of a validity of the respective first configuration;
the respective first indication is comprised in a first field in the first MAC CE;
the first MAC CE is a Recommended bit rate MAC CE;
the first field is a field “X”;
the respective first indication is comprised as a first flag in the first MAC CE;
the receiving is from a Central Unit managed by the network node;
the respective first configuration is an Information Element, IE, indicating a Radio Access Network, RAN, assistance supervised maximum encoding bit rate; and
the sending of the respective application layer measurement report is to the network node.

56. The wireless device of claim 53, wherein the respective first indication indicates one of:
that the respective first configuration has been activated or inactivated;
that the respective first configuration has been activated or inactivated for a session;
a maximum encoding rate to be used by the wireless device for application traffic;
a guaranteed bit rate to be provided to the wireless device;
whether the guaranteed bit rate is a minimum guaranteed bit rate, an average bit rate or a maximum bit rate;
a condition the respective first configuration is subject to;
that the respective first configuration is to be provided at a future timepoint, upon fulfillment of the condition;
the condition the respective first configuration is subject to, wherein the condition is other prioritized traffic at the network node;
that a resource allocated to the wireless device is temporarily reduced;
that the resource allocated to the wireless device is temporarily, increased;
a time period during which the respective first configuration is to remain active;
one or more conditions for the respective first configuration to remain active; and
a cancellation of a previously provided respective first configuration.

57. The wireless device of claim 56, wherein the applying of the received first configuration to the respective application layer measurement report is subject to the fulfillment of the condition.

58. The wireless device of claim 56, wherein the respective first indication indicates that the resource allocated to the wireless device is temporarily reduced, and wherein the respective first indication comprises at least one Information Element, IE, indicating at least one of:
QoS reduction is underway; and
one or more parameters the application is to abide by the one or more parameters being selected from:
RANInitiatedQoSReduction;
RANInitiatedQoSReductionDuration; and
RANInitiatedQoSReductionMaxEncoding rate.

59. The wireless device of claim 53, further configured to, before receiving the respective first indication:
send a respective first previous indication to the network node, the respective first previous indication indicating one or more capabilities of the wireless device, and wherein the received respective first indication is based on the sent respective first previous indication;
send a respective second previous indication to the network node, the respective second previous indication indicating an application used by the wireless device, and wherein the received respective first indication is based on the indicated respective application; and
send, to the network node, one or more respective third previous indications indicating the one or more respective measurements performed by the wireless device, the one or more respective measurements comprising at least one of:
application layer measurements; and
radio layer measurements;
wherein the received respective first indication is based on the sent respective third previous indication.

60. The wireless device of claim 59, wherein the respective third previous indication is a Radio Access Network Visible Quality of Experience, RVQoE, report.

61. A method performed by a network node, the method being for handling one or more application layer measurements, the network node operating in a wireless communications network, and the method comprising:
sending one or more respective first indications to at least one wireless device of the one or more wireless devices, each of the one or more respective first indications indicating:
a respective first configuration of a respective second indication of the one or more respective application layer measurements; and
that the respective first configuration is based on the one or more respective measurements, by the wireless device or other wireless devices, the one or more respective measurements comprising at least one of: application layer measurements and radio layer measurements; and
receiving a respective application layer measurement report from the wireless device based on the indicated respective first configuration.

62. A network node, for handling one or more application layer measurements, the network node comprising:
processing circuitry and memory containing instructions executable by the processing circuitry whereby the network node is configured to:
send one or more respective first indications to at least one wireless device of the one or more wireless devices, each of the one or more respective first indications being configured to indicate:
a respective first configuration of a respective second indication of the one or more respective application layer measurements; and
that the respective first configuration is based on the one or more respective measurements, by the wireless device or other wireless devices, the one or more respective measurements being configured to comprise at least one of: application layer measurements and radio layer measurements; and
receive a respective application layer measurement report from the wireless device based on the respective first configuration configured to be indicated.
